(19) United States
(12) Patent Application Publication
(10) Pub. No.: US 2009/0181747 A1
(43) Pub. Date: Jul. 16, 2009

(54) GAMING MACHINE PERFORMING DICE GAME USING ROULETTE HAVING EXTRA CAGE POCKET AND PLAYING METHOD THEREOF

(75) Inventor: Hiroyuki NAGANO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/175,029

(22) Filed: Jul. 17, 2008

Related U.S. Application Data
(60) Provisional application No. 61/020,508, filed on Jan. 11, 2008.

(51) Int. Cl. G06F 17/00

(52) U.S. Cl. 463/17

(57) ABSTRACT

A gaming machine 1 of the invention is a gaming machine that executes a game using identification information indicative of any one of numbers 1 to 6 and is programmed to store a bet area bet on, which area corresponds to any one of the identification numbers 1 to 6, and a credit placed as a bet on the bet area; to roll a ball 27 on a wheel 22 having pockets including numbered pockets 23 to which the identification number of 1 to 6 is allotted and an extra pocket mark 75 to which privilege information is allotted; when the ball 27 is received in a pocket including the extra pocket mark 75, to award a privilege, based on the privilege information; and when the ball 27 is received in any one of the pockets and the received identification information conforms to the bet area bet on, to award a payout, based on odds defined for the conforming bet area and the credit placed as a bet.

### CROSS REFERENCE TO RELATED APPLICATION

This application claims the benefit of U.S. Provisional Application No. 61/020,508, filed on Jan. 11, 2008, which application is incorporated herein by reference in its entirety.

### BACKGROUND OF THE INVENTION

1. Field of the Invention

The invention relates to a gaming machine and a playing method thereof.

2. Description of Related Art

Conventionally, there are many types of games using a dice, which have much popularity together with a card game, a roulette game and a slot game. For example, U.S. Patent Publication No. 2007/0018406 discloses a gaming machine that executes a Sic Bo game in which three dices are used to foresee the number of pips or a combination of the dices.

However, when it is intended to develop the gaming machine as a gaming machine like a slot machine, the hexahedral dice requires a complicated device with respect to operations of shaking the dice, interpreting the pip of the dice, withdrawing the dice and the like, so that it takes much cost for the development. In addition, if a video game is made so as to execute a game using a dice, a reality is lost, so that it is apt to be monotonous.

In the mean time, a roulette game is a game to foresee where a ball, which is thrown on a wheel being rotated, will fall. It is a famous game that can be said as a representative game in a casino and the like. The rules thereof are simple, so that there are many fans. For example, U.S. Patent Publication Nos. 2005/0032570 and 2006/0094493 disclose roulette gaming devices in which a betting board arranged in a grid type is used to foresee a number to be bet and to bet a chip.

An object of the invention is to provide a gaming machine capable of using a wheel, which is used in a roulette game, in a dice game to reduce the costs of development and to increase a player's game motivation while providing a realistic of the roulette game, and a playing method thereof.

### SUMMARY OF THE INVENTION

The invention provides a gaming machine that executes a game using identification information indicative of any one of numbers 1 to 6, the gaming machine including: a wheel having pockets including a plurality of numbered pockets to which the identification information indicative of any one of numbers 1 to 6 is allotted and an extra pocket to which privilege information is allotted; at least one ball that rolls on the wheel and is received in any one of the pockets; a win information detection device that detects the identification information allotted to the numbered pockets and the privilege information allotted to the extra pocket; a terminal device that has a plurality of bet areas corresponding to the identification information, and receives a game value placed as a bet on one or more of the bet areas and awards a payout, based on odds defined for the bet areas; and a controller programmed to operate as described in the steps of (a1) to (a4). Specifically, the controller operates: (a1) to store a bet area bet on and a game value placed as a bet in the terminal device; (a2) to roll the ball on the wheel; (a3) when the ball is received in the extra pocket, to award a privilege, based on the privilege information detected by the win information detection device; and (a4) when the ball is received in any one of the plurality of pockets and the identification information detected by the win information detection device conforms to the bet area bet on in the terminal device, to award a payout, based on odds defined for the conforming bet area bet on and the game value placed as a bet on the bet area.

According to the above structure, when a game is executed which uses a cube dice having the numbers of 1 to 6 indicated on each side thereof, a roulette to foresee when a ball, which is thrown on a wheel being rotated, will fall can be used, instead of the dice. In addition, when the ball is received in an extra pocket, it is possible to award a privilege based on the privilege information and to award a payout based on the privilege information and the bet area bet on in the terminal device. Thereby, a player familiar with a roulette game may play a game using a dice with a sense same as the roulette game. In addition, a game arcade may easily enable a player of a roulette game to take part in a game using a dice. Furthermore, since it is possible to provide various privileges (payout, bonus game and the like) to a player using the extra pocket that is not provided in a game using a dice, a new entertainment characteristic can be provided.

In addition, the invention provides the gaming machine according to claim 1, wherein the number of the numbered pockets may be thirty six and that of the extra pockets may be two.

According to the above structure, a sum of the pockets is 38. Thereby, a conventional roulette gaming device having 38 pockets can be used for development of the gaming machine of the invention, so that the development period and costs can be reduced.

In addition, the invention provides the gaming machine according to claim 1, wherein a game to be executed may be a Sic Bo that uses three balls and has a bet area relating to a combination of the three balls.

According to the above structure, in this gaming machine, it is possible to execute a Sic Bo that uses three balls and has a bet area relating to a combination of the three balls. By using a large-scaled wheel, which is used in a roulette game, in a Sic Bo that uses a small-scaled dice to execute a game, it is possible to provide a game to which many players pay attention.

Furthermore, the invention provides a gaming machine that executes a game using identification information indicative of any one of numbers 1 to 6, the gaming machine including: a wheel having a plurality of numbered pockets to which the identification information indicative of any one of numbers 1 to 6 is allotted and an extra pocket having the identification information indicative of any one of numbers 1 to 6; at least one ball that rolls on the wheel and is received in any one of the numbered pockets and the extra pocket; a win information detection device that detects the identification information allotted to the numbered pocket or extra pocket having received the ball; a terminal device that has a plurality of bet areas corresponding to the identification information, and receives a game value placed as a bet on one or more of the bet areas and awards a payout, based on odds defined for the bet areas; and a controller programmed to operate as described in the steps of (b1) to (b4). Specifically, the controller operates: (b1) to store a bet area bet on and a game value placed as a bet in the terminal device; (b2) to roll the ball on the wheel; (b3) when the ball is received in the extra pocket, to detect all of 1 to 6, as identification information; and (b4) when the ball is received in at least one of the numbered pockets and the extra pocket and the identification information detected by the win information detection device conforms to the bet area bet on in the terminal device, to award a payout, based on odds defined for the conforming bet area bet on and the game value placed as a bet on the bet area.

According to the above structure, when a game is executed which uses a cube dice having the numbers of 1 to 6 indicated on each side thereof, a roulette to foresee when a ball, which is thrown on a wheel being rotated, will fall can be used, instead of the dice. In addition, when the ball is received in an extra pocket, it is possible to detect, as privilege information, all of 1 to 6, as the identification information, and to award a payout, based on the detected identification information and the bet area bet on in the terminal device. Thereby, a player familiar with a roulette game may play a game using a dice with a sense same as the roulette game. In addition, a game arcade may easily enable a player of a roulette game to take part in a game using a dice. Furthermore, since it is possible to provide a player with a privilege that an extra pocket, which is not provided in a game using a dice, is handled as an almighty having the identification information indicative of any one of numbers 1 to 6, a new entertainment characteristic can be provided.

In addition, the invention provides the gaming machine according to claim 4, wherein the number of the numbered pockets may be thirty six and that of the extra pockets may be two.

According to the above structure, a sum of the numbered pockets and the extra pockets is 38. Thereby, a conventional roulette gaming device having 38 pockets can be used for development of the gaming machine of the invention, so that the development period and costs can be reduced.

In addition, the invention provides the gaming machine according to claim 4, wherein a game to be executed may be a Sic Bo that uses three balls and has a bet area relating to a combination of the three balls.

According to the above structure, in this gaming machine, it is possible to execute a Sic Bo that uses three balls and has a bet area relating to a combination of the three balls. By using a large-scaled wheel, which is used in a roulette game, in a Sic Bo that uses a small-scaled dice to execute a game, it is possible to provide a game to which many players pay attention.

Furthermore, the invention provides a gaming machine that executes a game using identification information indicative of any one of numbers 1 to 6, the gaming machine including: a wheel having a plurality of numbered pockets to which the identification information indicative of any one of numbers 1 to 6 is allotted and an extra pocket to which privilege information is allotted; a ball that rolls on the wheel and is received in any one of the numbered pockets and extra pocket; a win information detection device that detects the identification information allotted to the numbered pockets or the privilege information allotted to the extra pocket; a terminal device that has a plurality of bet areas corresponding to the identification information, and receives a game value placed as a bet on one or more of the bet areas and awards a payout, based on odds defined for the bet areas; and a controller programmed to operate as described in the steps of (c1) to (c4). Specifically, the controller operates: (c1) to store a bet area bet on and a game value placed as a bet in the terminal device; (c2) to roll the ball on the wheel; (c3) when the ball is received in the extra pocket and the privilege information is detected, to roll a plurality of new balls on the wheel; and (c4) when the new balls are received in any one of the numbered pockets and the identification information detected by the win information detection device conforms to the bet area bet on in the terminal device, to award a payout, based on odds defined for the conforming bet area bet on and the game value placed as a bet on the bet area.

According to the above structure, when a game is executed which uses a cube dice having the numbers of 1 to 6 indicated on each side thereof, a roulette to foresee when a ball, which is thrown on a wheel being rotated, will fall can be used, instead of the dice. In addition, when the ball is received in an extra pocket, it is possible to roll new balls on the wheel, as privilege information, and to award a payout based on the detected identification information and the bet area bet on in the terminal device. Thereby, a player familiar with a roulette game may play a game using a dice with a sense same as the roulette game. In addition, a game arcade may easily enable a player of a roulette game to take part in a game using a dice. Furthermore, since it is possible to provide a player with a privilege that an extra pocket, which is not provided in a game using a dice, is used to execute a game with the more balls than a base game, a new entertainment characteristic can be provided.

In addition, the invention provides the gaming machine according to claim 7, wherein the number of the numbered pockets may be thirty six and that of the extra pockets may be two.

According to the above structure, a sum of the pockets is 38. Thereby, a conventional roulette gaming device having 38 pockets can be used for development of the gaming machine of the invention, so that the development period and costs can be reduced.

In addition, the invention provides the gaming machine according to claim 7, wherein a game to be executed may be a Sic Bo that uses three balls and has a bet area relating to a combination of the three balls.

According to the above structure, in this gaming machine, it is possible to execute a Sic Bo that uses three balls and has a bet area relating to a combination of the three balls. By using a large-scaled wheel, which is used in a roulette game, in a Sic Bo that uses a small-scaled dice to execute a game, it is possible to provide a game to which many players pay attention.

Furthermore, the invention provides a gaming machine that executes a game using identification information indicative of any one of numbers 1 to 6, the gaming machine including: a wheel having a plurality of numbered pockets each of which has a display device that displays the identification information and an extra pocket mark; at least one ball that rolls on the wheel and is received in any one of the numbered pockets; a win information detection device that detects the identification information and the extra pocket mark displayed on the display device provided to the numbered pocket having received the ball; a terminal device that has a plurality of bet areas corresponding to the identification information, and receives a game value placed as a bet on one or more of the bet areas and awards a payout, based on odds defined for the bet areas; and a controller programmed to operate as described in the steps of (d1) to (d5). Specifically, the controller operates: (d1) to store a bet area bet on and a game value placed as a bet in the terminal device; (d2) to randomly determine and display identification numbers of 1 to 6 and the extra pocket mark on each display device; (d3) to roll the ball on the wheel; (d4) when the ball is received in the numbered pocket having the extra pocket mark displayed thereon and the extra pocket mark is detected, to detect all of 1 to 6, as identification information; and (d5) when the ball is received in any one of the numbered pockets and the identification information detected by the win information detection device conforms to the bet area bet on in the terminal device, to award a payout, based on odds defined for the conforming bet area bet on and the game value placed as a bet on the bet area.

According to the above structure, it is possible to randomly determine and display the identification numbers of 1 to 6 and the extra pocket mark on each display device. In addition, when the ball is received in an extra pocket, it is possible to detect, as privilege information, all of 1 to 6, as the identification information, and to award a payout, based on the detected identification information and the bet area bet on in the terminal device. Thereby, a player familiar with a roulette game may play a game using a dice with a sense same as the roulette game. In addition, a game arcade may easily enable a player of a roulette game to take part in a game using a dice. Furthermore, since it is possible to provide a player with a privilege that an extra pocket, which is not provided in a game using a dice, is handled as an almighty having the identification information indicative of any one of numbers 1 to 6, a new entertainment characteristic can be provided.

In addition, the invention provides the gaming machine according to claim 10, wherein a game to be executed may be a Sic Bo that uses three balls and has a bet area relating to a combination of the three balls.

According to the above structure, in this gaming machine, it is possible to execute a Sic Bo that uses three balls and has a bet area relating to a combination of the three balls. By using a large-scaled wheel, which is used in a roulette game, in a Sic Bo that uses a small-scaled dice to execute a game, it is possible to provide a game to which many players pay attention.

Furthermore, the invention provides a gaming machine that executes a game using identification information indicative of any one of numbers 1 to 6, the gaming machine including: a wheel having a plurality of numbered pockets each of which has a display device that displays the identification information and an extra pocket mark having privilege information allotted thereto; a ball that rolls on the wheel and is received in any one of the numbered pockets; a win information detection device that detects the identification information or the privilege information allotted to the extra pocket mark, the identification information and the privilege information being displayed on the display devices provided to the numbered pockets; a terminal device that has a plurality of bet areas corresponding to the identification information, and receives a game value placed as a bet on one or more of the bet areas and awards a payout, based on odds defined for the bet areas; and a controller programmed to operate as described in the steps of (e1) to (e5). Specifically, the controller operates: (e1) to store a bet area bet on and a game value placed as a bet in the terminal device; (e2) to randomly determine and display identification numbers of 1 to 6 and the extra pocket mark on each display device; (e3) to roll the ball on the wheel; (e4) when the ball is received in the numbered pocket having the extra pocket mark displayed thereon and the privilege information is detected, to roll a plurality of new balls on the wheel; and (e5) when the new balls are received in any one of the numbered pockets and the identification information detected by the win information detection device conforms to the bet area bet on in the terminal device, to award a payout, based on odds defined for the conforming bet area bet on and the game value placed as a bet on the bet area.

According to the above structure, it is possible to randomly determine and display the identification number of 1 to 6 and the extra pocket mark on each display device. In addition, when a game is executed which uses a cube dice having the numbers of 1 to 6 indicated on each side thereof, a roulette to foresee when a ball, which is thrown on a wheel being rotated, will fall can be used, instead of the dice. Additionally, when the ball is received in an extra pocket, it is possible to roll new balls on the wheel, as privilege information and to award a payout, based on the detected identification information and the bet area bet on in the terminal device. Thereby, a player familiar with a roulette game may play a game using a dice with a sense same as the roulette game. In addition, a game arcade may easily enable a player of a roulette game to take part in a game using a dice. Furthermore, since it is possible to provide a player with a privilege that an extra pocket, which is not provided in a game using a dice, is used to execute a game with the more balls than a base game, a new entertainment characteristic can be provided.

In addition, the invention provides the gaming machine according to claim 12, wherein a game to be executed may be a Sic Bo that uses three balls and has a bet area relating to a combination of the three balls.

According to the above structure, in this gaming machine, it is possible to execute a Sic Bo that uses three balls and has a bet area relating to a combination of the three balls. By using a large-scaled wheel, which is used in a roulette game, in a Sic Bo that uses a small-scaled dice to execute a game, it is possible to provide a game to which many players pay attention.

Furthermore, the invention provides a playing method of a game in which identification information indicative of any one of numbers 1 to 6 is used to repeatedly perform a game, the playing method including the steps of: storing a bet area bet on, which area corresponds to the identification information, and a game value placed as a bet; rolling a ball on a wheel having pockets including a plurality of numbered pockets to which the identification information indicative of any one of numbers 1 to 6 is allotted and an extra pocket to which privilege information is allotted; and when the ball is received in the extra pocket, awarding a privilege, based on the privilege information, and when the ball is received in any one of the plurality of pockets and the received identification information conforms to the bet area bet on, awarding a payout, based on odds defined for the conforming bet area bet on and the game value placed as a bet on the bet area.

According to the above structure, when a game is executed which uses a cube dice having the numbers of 1 to 6 indicated on each side thereof, a roulette to foresee when a ball, which is thrown on a wheel being rotated, will fall can be used, instead of the dice. In addition, when the ball is received in an extra pocket, it is possible to award a privilege based on the privilege information and to award a payout based on the privilege information and the bet area bet on in a terminal device. Thereby, a player familiar with a roulette game may play a game using a dice with a sense same as the roulette game. In addition, a game arcade may easily enable a player of a roulette game to take part in a game using a dice. Furthermore, since it is possible to provide various privileges (payout, bonus game and the like) to a player using an extra pocket that is not provided in a game using a dice, a new entertainment characteristic can be provided.

In addition, the invention provides the playing method according to claim 14, wherein the number of the numbered pockets may be thirty six and that of the extra pockets may be two.

According to the above structure, a sum of the pockets is 38. Thereby, a conventional roulette gaming device having 38 pockets can be used for development of the gaming machine of the invention, so that the development period and costs can be reduced.

In addition, the invention provides the playing method according to claim 14, wherein a game to be executed may be a Sic Bo that uses three balls and has a bet area relating to a combination of the three balls.

According to the above structure, in this gaming machine, it is possible to execute a Sic Bo that uses three balls and has a bet area relating to a combination of the three balls. By using a large-scaled wheel, which is used in a roulette game, in a Sic Bo that uses a small-scaled dice to execute a game, it is possible to provide a game to which many players pay attention.

### BRIEF DESCRIPTION OF THE DRAWINGS

FIG. 1 illustrates a playing method of a gaming machine relating to a first game execution process;

FIG. 2 is a block diagram of a gaming device;

FIG. 3 is a perspective view showing an external appearance of a gaming machine;

FIG. 4 is a plan view of a roulette unit;

FIG. 5 illustrates a BET screen;

FIG. 6 is a block diagram schematically showing a control system of a gaming machine;

FIG. 7 is a block diagram schematically showing a control system of a station;

FIG. 8 shows a payout odds table;

FIG. 9 is a flow chart of a first game execution process program;

FIG. 10 is a flow chart of a display number determining process program;

FIG. 11 shows a display number lottery table;

FIG. 12 is a flow chart of a game execution process program that is performed in a station;

FIG. 13 shows a game result relating to a first game execution process;

FIG. 14 illustrates a playing method of a gaming machine relating to a second game execution process;

FIG. 15 is a flow chart of a second game execution process program; and

FIG. 16 shows a game result relating to a second game execution process.

### DESCRIPTION OF THE PREFERRED EMBODIMENTS

Hereinafter, a gaming machine and a playing method according to an embodiment of the invention will be described.

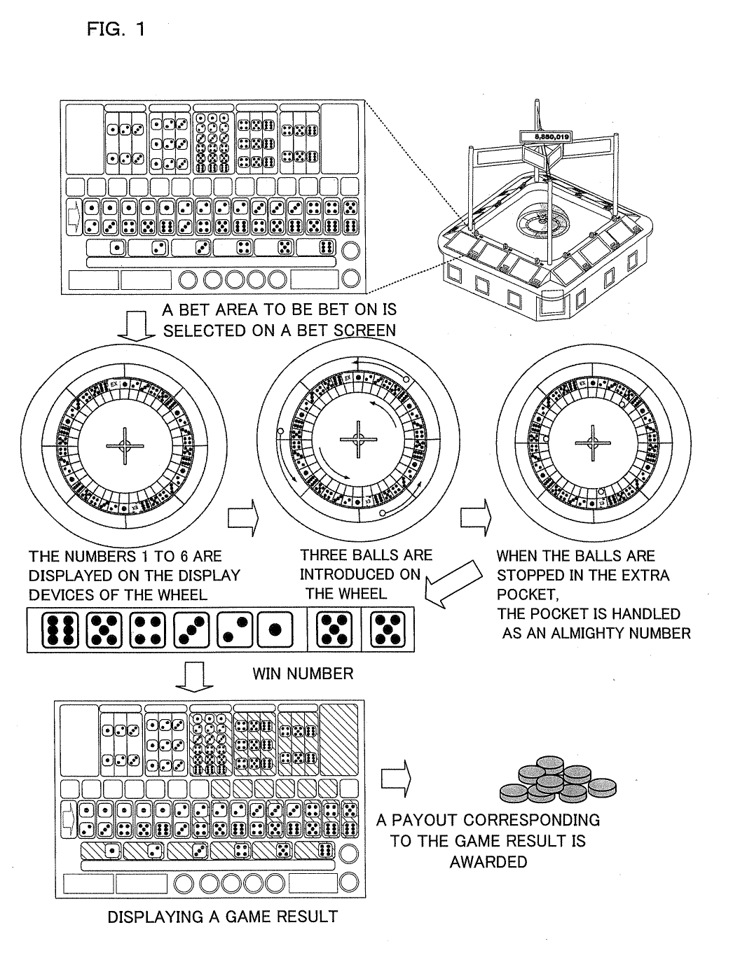

As shown in FIG. 1, a gaming machine executes a playing method including the steps of: storing a bet area bet on, which area corresponds to the identification information, and a game value placed as a bet; randomly determining and displaying identification numbers of 1 to 6 on each display device; rolling a ball on a wheel having pockets including a plurality of numbered pockets to which the identification information indicative of any one of numbers 1 to 6 is allotted and an extra pocket to which privilege information is allotted; and when the ball is received in the extra pocket, awarding a privilege, based on the privilege information, and when the ball is received in any one of the plurality of pockets and the received identification information conforms to the bet area bet on, awarding a payout, based on odds defined for the conforming bet area bet on and the game value placed as a bet on the bet area.

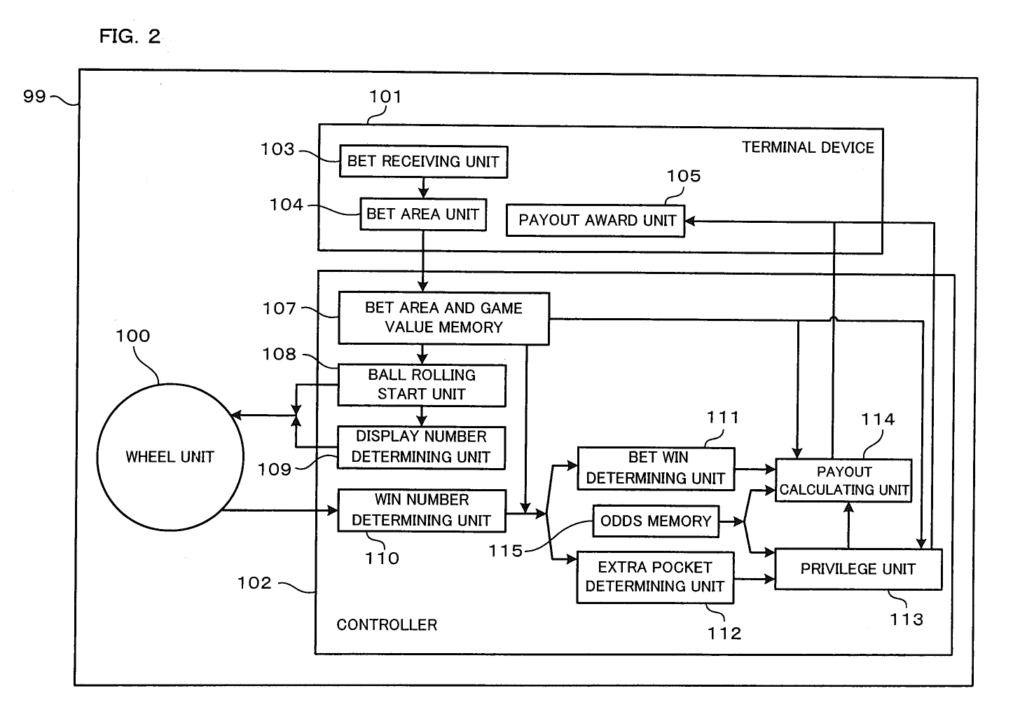

A gaming machine 99 that executes the above playing method has a terminal device 101, a wheel unit 100 that executes a main game and a controller 102, as shown in FIG. 2. The terminal device 101 is structured to arrange a bet receiving unit 103 that receives a game value, a bet area unit 104 that becomes a bet target and a payout award unit 105 that awards a payout. In the mean time, the terminal device 101 has an image display device that displays the bet area unit 104 and a touch panel for a bet operation.

(Structure of the Controller 102)

The controller 102 has a memory 107 that stores information of a bet area and a game value, which a player makes a bet from the terminal device 101, and an odds memory 115 that stores a payout rate corresponding to a bet-type.

In addition, the controller 102 has a ball rolling start unit 108 that rolls a ball on the wheel unit 100, a display number determining unit 109 that determines an extra pocket mark having identification number of 1 to 6 and privilege information allotted thereto to be displayed on the wheel unit and a win number determining unit 110 as a win number detection device that determines a number regarded as a win number of the wheel unit 100. Further, it has a bet win determining unit 111 that determines whether the win number conforms to a bet area stored in the memory 107, an extra pocket determining unit 112 that determines an extra pocket mark, a payout calculating unit 114 that calculates a payout to be cashed out to a player, and a privilege unit 113 that awards a privilege.

The controller 102 may be embodied in hardware or software, as required.

(Operations of the Controller 102)

With the above structure, an operation of the controller 102 will be described. In each terminal device 101, the bet receiving unit 103 receives a game value. When a player bets the game value on a bet area unit 104 selected, the memory 107 stores therein the bet area bet on by the player and the game value placed as a bet on the bet area. Before and after a predetermined bet receiving time is over, a ball is rolled on the wheel unit 100 in response to a signal from the ball rolling start unit 108. In addition, an identification number and an extra pocket mark to be displayed on the wheel unit 100 are determined in the display number determining unit 109. After that, the win number determining unit 110 specifies a number on which the rolling ball is stopped in the wheel unit 100. After that, when it is determined in the extra pocket determining unit that there is an extra pocket mark in the wheel unit 100 on which the ball is stopped, a privilege is awarded in the privilege unit 113. Then, the bet win determining unit 111 determines whether the number determined by the win number determining unit 110 conforms to the bet area stored in the memory 107. When they conform to each other, the payout calculating unit 114 calculates a payout corresponding to the bet area bet on, based on the payout odds corresponding to a bet type stored in the odds memory 115, taking the privilege awarded in the privilege unit 113 into consideration. Then, a game value corresponding to the payout calculated in the payout calculating unit 114 is awarded from the payout award unit 105.

(Display State of the Terminal Device)

In the followings, a state to be displayed on the terminal device 101 in the gaming machine 99 will be described.

A player makes a bet, based on the bet area unit 104 displayed on the image display device of the terminal device 101. After a bet time is over, a ball is introduced to the wheel unit 100 from the ball rolling start unit 108. When the extra pocket determining unit determines that there is an extra pocket mark in the wheel unit 100, on which the ball is stopped, the image display device notifies that the privilege unit 113 has awarded a privilege. In addition, the image display device displays a display or letter for the bet win determining unit 111 to notify that a bet area conforming to a number determined by the win number determining unit 110 wins. After that, when there is a cashout, the image display device displays the game value that is increased as the cashout-number. Thus, a game is over and a bet area unit 114 is displayed so as to receive a bet of a next game.

(Mechanical Structure: Schematic Structure)

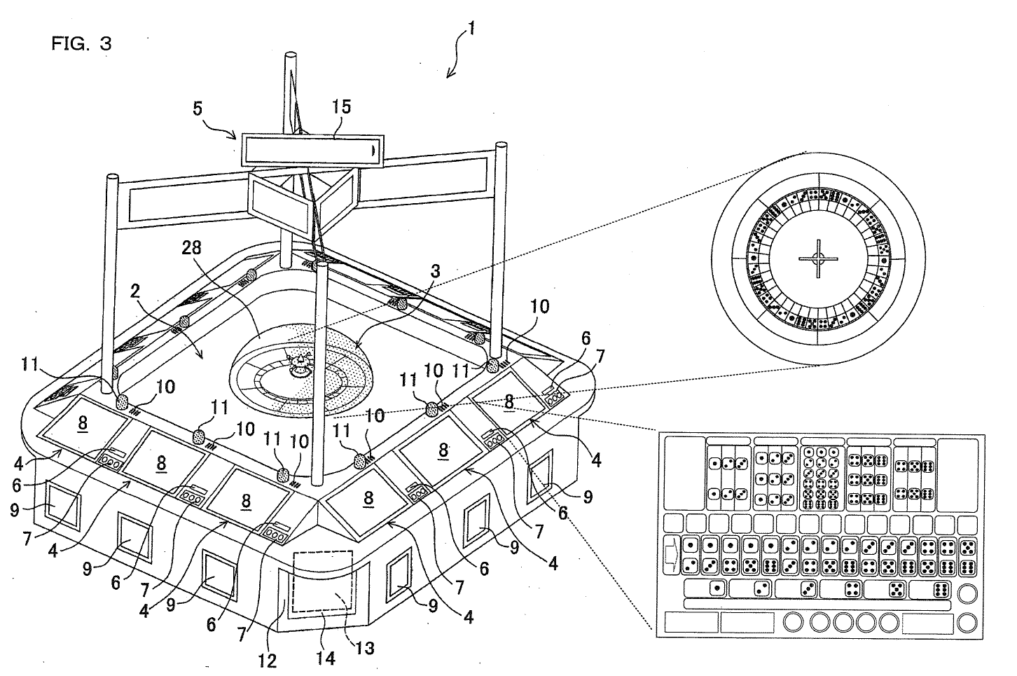

In the followings, it will be specifically described a case where the gaming machine 99 is applied to a gaming machine 1. FIG. 3 is an external perspective view showing a schematic structure of a gaming machine 1 according to an embodiment. The gaming machine 1 has a cabinet 2, a roulette unit 3, stations 4 and an electric light indicator 5. The cabinet 2 fixes the roulette unit 2, the stations 4 and the electric light indicator 5 at predetermined positions and protects a device equipped therein such as electronic substrate. Meantime, a game to be executed in this embodiment is a Sic Bo game that uses three balls and has BET areas 57, 58, 59, 60A, 60B, 61, 62, 63 as a bet area relating to a combination of the three balls.

According to the above structure, by using a large-scaled wheel, which is used in a roulette game, in a Sic Bo that uses a small-scaled dice to execute a game, it is possible to provide a game to which many players easily pay attention.

In the mean time, the game to be executed is described as a Sic Bo in this embodiment. However, the invention is not limited thereto. For example, a game using a dice, such as CRAPS may be possible.

The roulette unit 3 is equivalent to the wheel unit 100 of FIG. 2 and is disposed about at a central part of the cabinet 2. The stations 4 are equivalent to the terminal devices 101 of FIG. 2 and are disposed around the roulette unit 3. To be more specific, the 12 stations 4 are disposed to surround the roulette unit 3. The station 4 serves as a bet receiving unit 103 for receiving a bet operation of a player and a payout award unit 105 for awarding a credit. The bet operation is an operation that a player expecting a win number of the roulette unit 3 inputs the contents such as number corresponding to the expected win number.

The electric light indicator 5 has an information indicator 15. The information indicator 15 is mounted on a top of the electric light indicator 5. Thereby, the information indicator 15 allows all players who play a game in the stations 4 to see the contents of display.

In addition, the gaming machine 1 has a server 13. The server 13 is equivalent to the controller 102 of FIG. 2. The server 13 is disposed at a corner part 12 of the cabinet 2. The server 13 is received in an inner space of the corner part 12. The inner space of the corner part 12 can be opened/shut by means of a corner door 14 having an authentication key attached. The corner door 14 is typically shut so that a player cannot operate the server 13. In the mean time, in the operation of the server 13, the corner door 14 is opened by operating an authentication key. Thereby, the server 13 is operated from an outside of the cabinet 2, so that the gaming machine 1 can be variously set.

(Mechanical Structure: Roulette Unit 3)

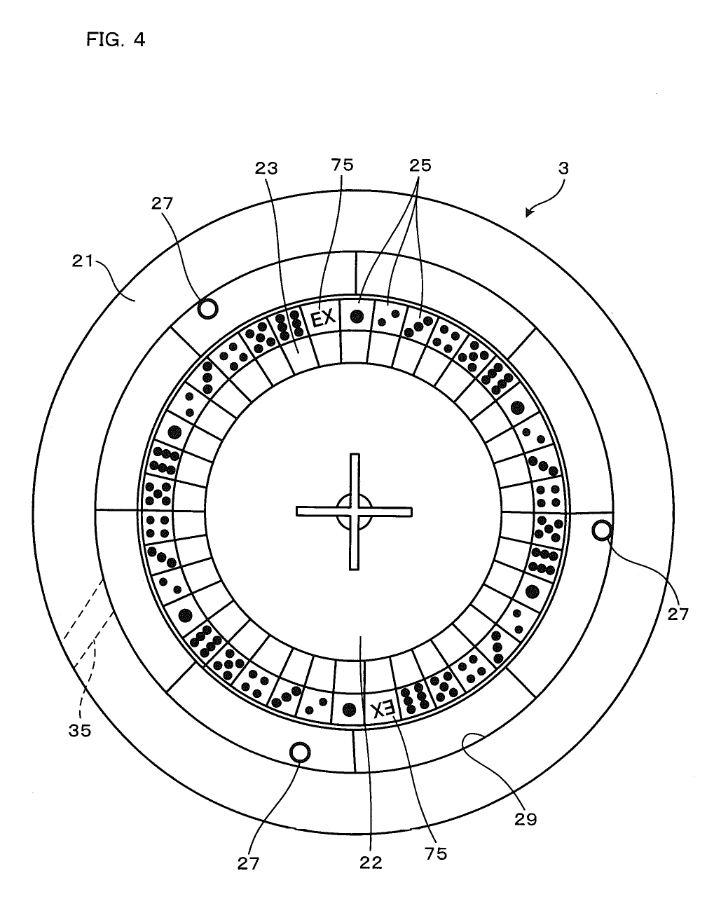

A structure of the roulette unit 3 will be described with reference to FIG. 4. FIG. 4 is a plan view of the roulette unit 3 according to an embodiment. The roulette unit 3 includes a frame 21 fixed to the cabinet 2 and a wheel 22 disposed at an inner side of the frame 21. As shown in FIG. 3, an entire upper part of the roulette unit 3 is covered by means of a hemisphere cover member 28 made of transparent acryl.

As shown in FIG. 4, the wheel 22 is received in the frame 21 and its upper surface is exposed to an outside. The wheel 22 is horizontally disposed so that a center axis of rotation thereof is identical to a vertical direction, and is supported to freely rotate so that a center point thereof is a rotation center. The wheel 22 has a plurality of numbered pockets 23 (38 pockets in this embodiment). The numbered pockets 23 are disposed in a ring shape at a periphery of an upper surface of the wheel 22. Each of the numbered pockets 23 is shaped in a recess shape having a size and a depth capable of receiving a ball 27.

According to the above structure, a sum of the numbered pockets is 38. Thereby, a conventional roulette gaming device having 38 pockets can be used for development of the gaming machine 1 of the invention, so that the development period and costs can be reduced.

Furthermore, the wheel 22 has numbered display plates 25 as a display device corresponding to each numbered pocket 23. The numbered display plates 25 are set to have the number same as that of the numbered pockets 23. The numbered display plate 25 enables each number of “1” to “6” with a design showing the pips of a dice and a design of “EX” as an extra pocket mark to be displayed. The numbered display plates 25 are disposed at the peripheries of the numbered pockets 23, respectively. Thereby, the numbered pockets 23 can display a design showing the pips of a dice, which indicates one of the numbers, and a design showing an extra pocket mark 77, among “1” to “6” and “EX” of the numbered display plates 25. Here, the extra pocket mark 75 serves as a trigger that awards various privileges in a game to be executed in the gaming machine 1.

According to the above structure, it is possible to randomly display the identification numbers of “1” to “6” and the extra pocket mark 75 on the respective numbered display plates 25. Thereby, it is possible to provide a player with a new entertainment characteristic.

The frame 21 that the wheel 22 is disposed at the center of the frame is inclined downward at a small degree from the periphery to the wheel 22. The frame 21 has a guide wall 29. The guide wall 29 is disposed between the periphery of the frame 21 and the wheel 22. The guide wall 20 guides an inserted ball 27 against centrifugal force, thereby allowing the ball 28 to roll.

In addition, the frame 21 has a ball insertion slot 35. The ball insertion slot 35 is opened to the wheel 22. The ball insertion slot 35 is associated with a ball insertion device (not shown) that is equipped in the frame 21. The ball insertion device as the ball rolling start unit 108, which is shown in FIG. 2, is structured to introduce the balls 27 on the wheel 22 from the ball insertion slot 35.

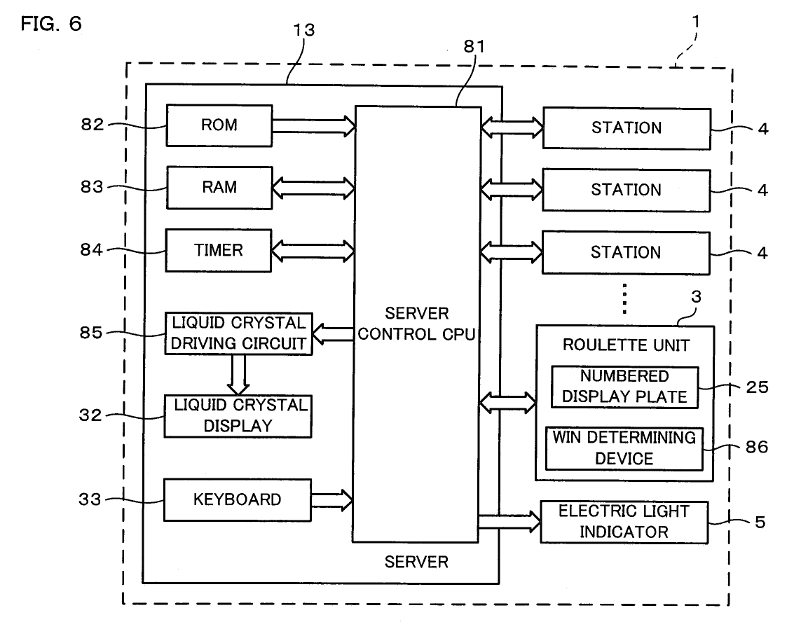

Further, the roulette unit 3 has a win determining device 86 of FIG. 6 and a ball collection device (not shown). The win determining device 86 and the ball collection device are disposed below the wheel 22. The win determining device 86 as the win number determining unit 110 and the extra pocket determining unit 112 is a device for determining a symbol (“1” to “6”, “EX”) of the designs displayed on the numbered display plate 25 corresponding to the numbered pocket 23 having the ball 27 received therein. When the balls 27 are received in the numbered pockets 23, the win determining device 86 determines the symbols of the design displayed on the numbered display plates 25 as the number of the balls received. Furthermore, the roulette unit 3 has a ball collection device (not shown). The ball collection device is a device for collecting the balls 27 on the wheel 22 after a roulette game is over. In the mean time, since the ball insertion device, the win determining device 86 and the ball collection device have been already known, the detailed descriptions thereof will be omitted.

In the roulette unit 3 structured as described above, when three balls 27 are introduced on the frame 21 by the ball insertion device, the guide wall 29 guises the balls 27 against the centrifugal force of the balls 27, thereby enabling the balls 27 to roll. When the centrifugal force is decreased as the rotation speed of the balls 27 is lowered, the balls 27 are rolled down along the inclined surface of the frame 21, are moved to the inside and reach the wheel 22 being rotated. The balls 27, which are rolling-introduced onto the wheel 22, pass over the numbered plates 25 at the periphery of the wheel 22 and then are received in some of the numbered pockets 23. As a result, the numbers indicated on the numbered display plates 25 corresponding to the numbered pockets 23 having the three balls 27 received therein are determined by the win determining device 86, so that win numbers are determined.

(Mechanical Structure: Server 13)

The server 13 shown in FIGS. 3 and 6 is equipped in a space 31 opened at a wall surface of the cabinet 2. The sever 13 is associated with each station 4. The server 13 transmits a command signal to each of the stations 4 to initiatively control each station 4, thereby progressing a game. In addition, the server 13 performs a maintenance operation for the gaming device 1, in addition to the control of a game of the gaming device 1.

A liquid crystal display 32 and a keyboard 33 are associated with the server 13. The liquid crystal display 32 displays a menu screen (not shown) or maintenance screen (not shown). In addition, the keyboard 33 is an operating means having several keys disposed thereon. In a state that a menu screen or maintenance screen is displayed on the liquid crystal display 32, when an operator operates the keyboard 33, the maintenance operation as well as various settings in the roulette gaming device 1 can be made. In the mean time, as described below, an operation of the keyboard 33 under state that a maintenance screen is displayed on the liquid crystal display 32 enables a setting of whether the server control CPU 81 executes a first game execution process program or second game execution process program.

(Mechanical Structure: Station 4)

As shown in FIG. 3, the station 4 has a medal insertion slot 6, a control unit 7 and an image display device 8. The medal insertion slot 6 is used to insert money or a game medium used in a game such as chip, medal and the like. The control unit 7 has several operating parts such as control button and the like. The operating parts are used to input an instruction by a player. The image display device 8 displays an image relating to a game and a BET screen 50 that receives a bet operation of a player. Thereby, the image display device 8 enables a player to operate the touch panel 56 or control unit 7 while seeing an image or BET screen 50.

The control unit 7 is disposed at a side of the image display device 8. The control unit 7 has buttons each of which being operated by a player. To be more specific, the control unit 7 has a participation button 68 that is used to take part in a game, an end button 69 that ends a game, and a release button 70 that releases all the bets. The participation button 68, the end button 69 and the release button 70 are disposed in an order from left, seen from a position opposite to the station 4.

The image display device 8 is a liquid crystal display of a touch panel type having the touch panel 50 attached to a front thereof. When an icon displayed on the liquid crystal is pushed with a finger and the like, the icon is selected.

In addition, the respective stations 4 have medal payout slots 9, speakers 10 and WIN lamps 11. The medal payout slots 9 are disposed at the sides of the cabinet 2. The speakers 10 are disposed above a top-right of the image display device 8. The WIN lamps 11 are disposed at sides of the speakers 10. The speakers 10 are used to output a music or effect music relating to a game. The WIN lamps 11 are turned on when a BET area bet on in the station 4 wins.

In the mean time, the WIN lamps 11 are disposed at positions that can be seen from all the stations 4 (12 stations in this embodiment). Thereby, the WIN lamps 11 enable another player to easily check a lighting state during the game in the same roulette gaming machine 1.

A medal sensor (not shown) is provided in the medal insertion slot 6. The medal sensor validates a medal inserted into the medal insertion slot 6 and counts the inserted medal. In addition, the medal payout slot 9 is connected to a hopper (not shown). The hopper pays out the predetermined number of medals from the medal payout slot 9.

(Electrical Structure: Server 13)

FIG. 6 is a block diagram that schematically shows a control system of the gaming machine 1. As shown in FIG. 6, the gaming machine 1 includes a server 13 and several stations 4 (12 stations in this embodiment) associated with the server 13. The server 13 is associated with the roulette unit 3 and the electric light indicator 5. In the mean time, a control system of the station 4 will be specifically described later.

In addition, the server 13 includes a server control CPU 81 serving as a calculation and control device performing an entire control, a ROM 82 and a RAM 83, a timer 84 associated with the server control CPU 81, a liquid crystal display 32 associated with the CPU through a liquid crystal driving circuit 85 and a keyboard 33.

The server control CPU 81 executes a variety of processes, based on input signals supplied from the respective stations 4 and data or program stored in the ROM 82 and the RAM 83. Thereby, the serve control CPU 81 transmits a command signal to the stations 4 based on execution results of the processes to initiatively control the respective stations 4, thereby progressing a game. Further, the server control CPU 81 drives a drive motor provided to the roulette unit 3, thereby shooting a ball 27 or rotating the wheel 22. Furthermore, the server control CPU 81 as the win number determining unit 110 controls the win determining device 86, thereby determining a win number based on a dropped position of the ball. Then, based on the win number obtained and the bet information transmitted from the respective stations 4, the server control CPU 81 as the bet win determining unit 111 determines a win of the chips bet. In addition, the server control CPU 81 as the payout calculating unit 114 calculates the credit-number to be paid out in each of the stations 4.

In addition, when the win determining device 86 detects an extra pocket mark 75, the server control CPU 81 serves as the privilege unit 113 that awards a privilege in accordance with a setting in the server 13.

Furthermore, the server control CPU 81 uses a display number determining table (which will be described later) to determine a design to be displayed on the numbered display plates 25 (a design of the pips of a dice of “1” to “6” and a design showing an extra pocket mark 75) in lottery. In other words, it is equivalent to the display number determining unit 109 of FIG. 2.

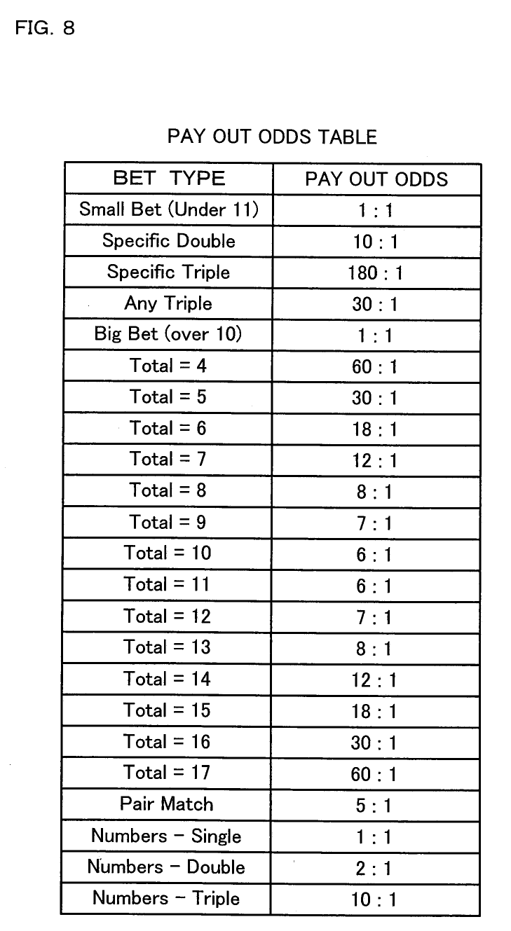

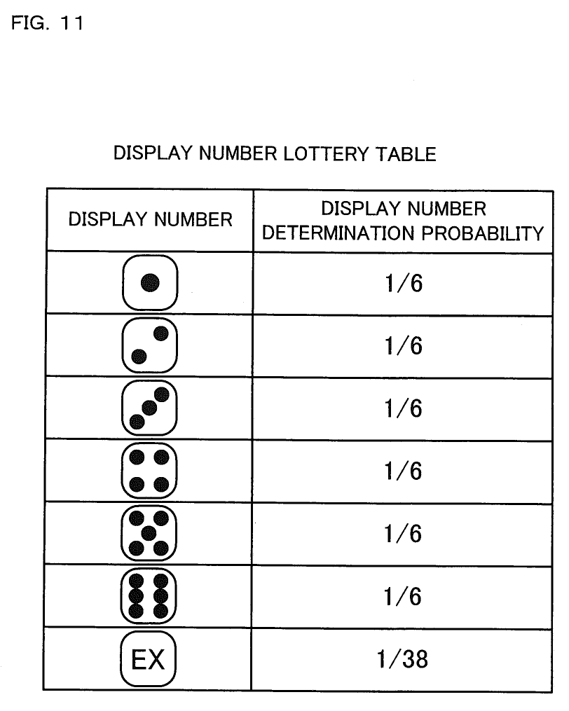

The ROM 82 includes a semiconductor memory, for example. The ROM 82 stores a program (for example, a program that executes a first game execution process and a second game execution process (which will be described later), a program that executes a display number determining process) for implementing basic functions of the gaming machine 1, a payout odds table that determines a payout rate (payout-number of credits for a win per one chip) for a game shown in FIG. 8, a display number lottery table shown in FIG. 11, a program for initiatively controlling the respective stations 4, and the like. In the mean time, the ROM 82 is equivalent to the odds memory 115 shown in FIG. 2.

The RAM 83 temporarily stores the bet information of chips to be supplied from the respective stations 4, a win number of the roulette unit 3 determined by a sensor, data relating to a result of a process that is executed by the server control CPU 81, and the like. In the mean time, the RAM 83 is equivalent to the bet area and game value memory 107 shown in FIG. 2.

Further, the server control CPU 81 is associated with a timer 84 that measures time. The time information of the timer 84 is transmitted to the server control CPU 81. The server control CPU 81 rotates the wheel 22 or introduces the ball 27, based on the time information of the timer 84.

In addition, the server control CPU 81 is associated with the electric light indicator 5. The server control CPU 81 controls light emission of a light emitting means such as LED to perform an effect by an electric spectacular and to display predetermined letters or time information of the timer 84 on the electric light indicator 5.

In addition, the ROM 82 is provided with a memory area corresponding to payout odds relating to a roulette game using the BET screen 50. The memory area stores data of a bet type or payout odds in a form of a payout management table. The payout management table will be specifically described later.

Furthermore, the RAM 83 is provided with a bet information memory area in which the bet information of a player who is playing a game is stored. The bet information memory area stores data of bet information or participation object in a form of a station management table. The station management table will be specifically described later. Further, the RAM 83 is provided with a win number memory area in which a win number of the roulette unit 3 determined by the win determining device 86 is stored. In the mean time, the bet information is information about a bet that is made using the stations 4, such as the bet area 72 displayed on the BET screen 50, the number of bet chips (bet-number) and bet type.

(Electrical Structure: Station 4)

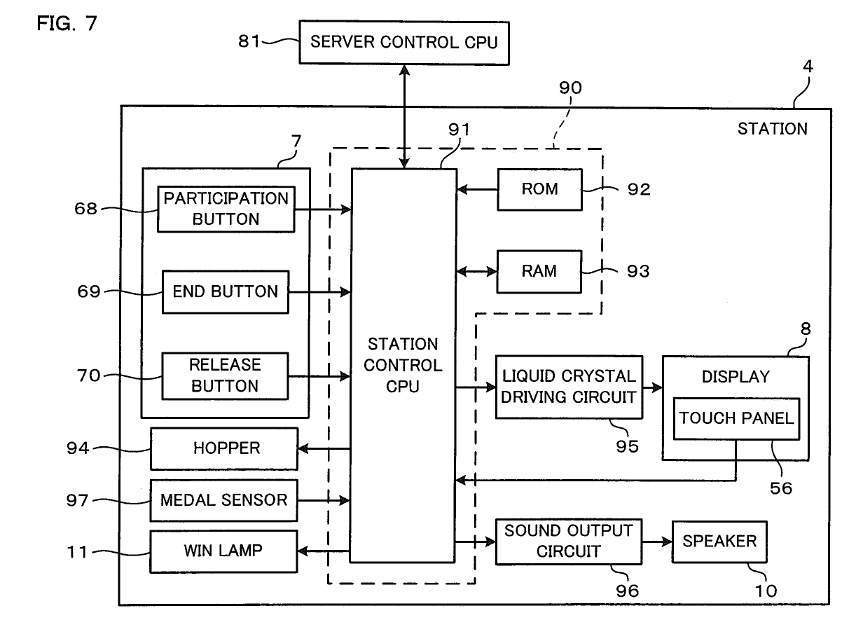

In the followings, a structure of a control system of the station 4 will be described. FIG. 7 is a block diagram showing a control system of the station according to an embodiment. In the mean time, the twelve stations 4 have a same structure, so that one station 4 will be described as an example.

The station 4 includes a station control unit 90 and several peripheral devices. The station control unit 90 includes a station control CPU 91, a ROM 92 and a RAM 93. The ROM 92 includes a semiconductor memory, for example. The ROM 92 stores a program for implementing basic functions of the station 4, various programs (for example, a program for executing a game execution process that is performed in the station) necessary for controlling the station 4, a data table and the like. In addition, the RAM 93 is a memory that temporarily stores various data calculated in the station control CPU 91, the number of credits that are currently possessed by a player (i.e., stored in the station 4), a bet situation of chips by a player, and the like.

In addition, the station control CPU 91 is associated with the participation button 68, the end button 69 and the release button 70, which are equipped in the control unit 7. Based on operation signals outputted as the respective buttons are pushed, the station control CPU 91 performs a control so as to execute the corresponding operations. To be more specific, based on an input signal that is inputted from the control unit 7 as an operation of a player is received and the data or program stored in the ROM 92 and the RAM 93, the station control CPU executes a variety of processes and transmits the results thereof to the server control CPU 81. In the mean time, the station control CPU 91 receives a command signal from the server control CPU 81, controls the peripheral devices constituting the station 4 and progresses a game in the station 4. In addition, the station control CPU 91 executes a variety of processes, based on an input signal that is inputted from the control unit 7 as an operation of a player is received and the data or program stored in the ROM 92 and the RAM 93, depending on contents of process, controls the peripheral devices constituting the station 4 based on the process results and progresses a game in the station 4.

In addition, the station control CPU 91 is associated with a hopper 94. The hopper 94 pays out the predetermined number of medals from the medal payout slot 9 in accordance with a command signal from the station control CPU 91. Furthermore, the station control CPU 91 is connected with an image display device 8 through a liquid crystal driving circuit 95. The liquid crystal driving circuit 95 includes a program ROM, an image ROM, an image control CPU, a work RAM, a VDP (video display processor), a video RAM and the like. The program ROM stores an image control program for display on the image display device 8, a variety of selection tables and the like.

In addition, the image ROM stores dot data for forming an image to be displayed on the image display device 8, for example. The image control CPU determines an image to be displayed on the image display device 8 from the dot data previously stored in the image ROM, in accordance with an image control program previously stored in the program ROM, based on parameters set in the station control PCU 91. In addition, the work RAM includes a temporary memory means used when the image control program is executed in the image control CPU. In addition, the VDP forms an image relating to contents of display determined in the image control CPU and outputs the image on the image display device 8. In the mean time, the video RAM is structured as a temporary memory means used when an image is formed in the VDP.

In addition, a touch panel 56 is attached on a front of the image display device 8. Operation information of the touch panel 56 is transmitted to the station control CPU 91. On the touch panel 56, a player makes a bet operation with chips on the BET screen 50. To be more specific, a player operates the touch panel 56 with regard to a selection of the respective bet areas 57, 58, 59, 60A, 60B, 61, 62, 63 in the table-type betting board 51, an operation of unit BET buttons 52A, 52B, 52C, 52D, an operation of the BET decision button 47, an operation of the cashout button 48, an operation of the help button 49 and the like, and the operation information is transmitted to the station control CPU 91. Based on the information, the current bet information of a player (a bet area indicated on the BET screen 50 and the number of chips bet) is stored in the RAM 93 at all times. Furthermore, the bet information is transmitted to the server control CPU 81 and is stored in the bet information memory area of the RAM 83.

Furthermore, a sound output circuit 96 and a speaker 10 are connected to the station control CPU 91. The speaker 10 generates a variety of effect sounds when performing various effects, based on an output signal from the sound output circuit 96.

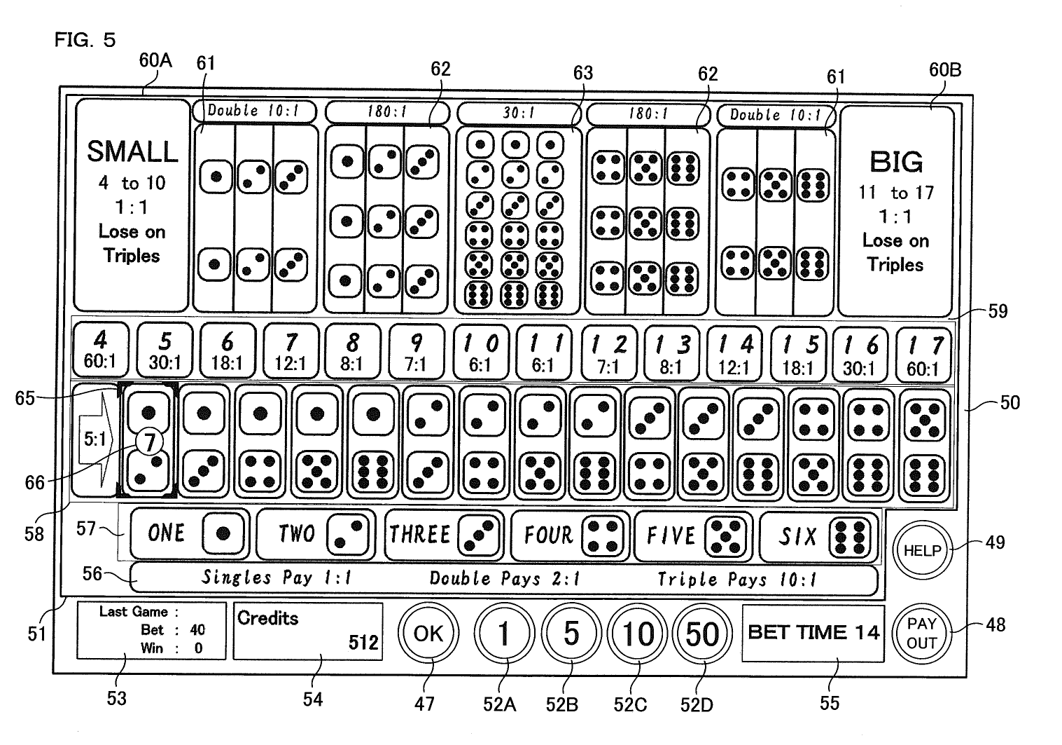

In addition, a medal sensor 97 is associated with the station control CPU 91. The medal sensor 97 detects medals inserted from the medal insertion slot 6, calculates the inserted medals and transmits a result thereof to the station control CPU 91. The station control CPU 91 increases the credit-number possessed by a player, which is stored in the RAM 93, based on the transmitted signal. Furthermore, as shown in FIG. 5, the station control CPU enables the credit-number indicator 54 on the BET screen 50 to display a credit-number.

In addition, a WIN lamp 11 is associated with the station control CPU 91. When the chip bet on the BET screen 61 wins, the station control CPU 91 turns on the WIN lamp 11 in a predetermined color.

(Data Table: Payout Odds Table)

In the followings, a payout odds corresponding to a bet-type shown in FIG. 8 will be described. The payout odds table that determines a payout odds corresponding to a bet-type is stored in the ROM 82 of the server 13. The payout odds corresponding to a bet-type has a column of bet-types and a column of payout odds. The data showing bet-types such as “Small Bet”, “Specific Double”, “Specific Triple” and the like are stored in the column of bet-types. The bet-types will be specifically described. The data showing the payout rates such as “1:1”, “10:1”, “180:1” and the like are stored in the column of payout odds, correspondingly to the bet types. Thereby, when a bet is made in a bet type of “Specific Double”, 10 pieces will be paid out per 1 piece bet. The payout odds for each bet-type are set as values based on a probability that a ball 27 will roll on the wheel 22 and will be received in the numbered pocket 23, as shown in the payout odds table of FIG. 8. In the mean time, the “payout odds” is a payout-number of credits for a win. In addition, a “win” means that a winning is made.

(Data Table: Display Number Lottery Table)

In the followings, a display number lottery table shown in FIG. 11 will be described. The display number lottery table is stored in the ROM 82 of the server 13. The display number lottery table showing a corresponding display number determination probability for “1” to “6” represented as the pips of a dice and a display number indicating the extra pocket mark 75, which are displayed on the respective numbered display plates 25, has a column of display numbers and a column of display number determining probabilities. In the column of the display numbers, the data are stored which indicate designs showing the numbers of “1” to “6” represented as the pips of a dice and the extra pocket mark 75. In the column of the display number determining probabilities, the data are stored which a probability that the designs of the dice showing the numbers of “1” to “6” will be displayed on the numbered display plates 25 is a “value of 1/6” and a probability that the design of “EX” of the extra pocket mark 75 will be displayed on the numbered display plates 25 is a “value of 1/38”, correspondingly to the respective display numbers. Thereby, when a display number determining process that will be described later is executed, one of the display numbers of “1” to “6” and “EX” is determined in lottery in a predetermined probability, based on the display number lottery table, so as to display it on each numbered display plate 25 and the determined display number can be displayed on the numbered display plates 25.

(Data Table: Station Management Table)

In the followings, a station management (not shown) will be described. The station management table is stored in the RAM 83 of the server 13. The station management table has a column of stations, a column of bet information having a column of bet types and a column of bet-numbers and a column of participation objects. The column of stations stores the machine number data inherent to each station 4. The column of bet types stores the data of the bet types. The column of bet-numbers stores the number of pieces bet such as “20.” The column of participation objects stores the data showing whether a participation object has a possibility that a payout will be awarded thereto. In the mean time, the “1” in the column of participation objects shows that it is set as a participation object and “0” shows that it is not set as a participation object.

(Display State of the Image Display Device 8)

First, the BET screen 50 that is displayed on the image display device 80 will be described with reference to FIG. 5. In the table-type betting board 51 that displays a variety of bet areas to be displayed on the BET screen 50, designs of dices showing “1” to “6” corresponding to the pips of a dice displayed on the numbered display plates 25, a combination of the designs of the dices, a summed number of the pips of the dice displayed on the numbered display plates 25 are arranged. In the mean time, each bet area is equivalent to the bet area unit 104 shown in FIG. 2.

In addition, on a lower part of the BET screen 50 are displayed a BET decision button 47, unit BET buttons (1 BET button 52A, 5 BET button 52B, 10 BET button 52C, 50 BET button 52D), a cashout result indicator 53, a credit-number indicator 54, a BET timer count 55, a cashout button 48 and a help button 49.

The unit BET buttons are provided for a player to select the number of chips to be bet on bet areas 57, 58, 59, 60A, 60B, 61, 62, 63 (above a combination of the designs of the dice and a summed number of the pips of the dice displayed on the numbered display plates 25) in the table-type betting board 51, indicated by the player. The unit BET buttons include a 1 BET button 52A, a 5 BET button 52B, a 10 BET button 52C and a 50 BET button 52D. A player first pushes the screen with a finger, thereby indicating a bet area, on which a bet is made, with a cursor 65. At this state, when the player pushes the 1 BET button 52A, the player bets a chip in a unit of one piece (whenever the 1 BET button 52A is pushed with a finger, the bet-number is increased in an order of “1”·“2”·“3” . . . ). In addition, when the player pushes the 5 BET button 52B, the player bets chips in a unit of five pieces (whenever the 5 BET button 52B is pushed with a finger, the bet-number is increased in an order of “5”·“10”·“15” . . . ). In addition, when the player pushes the 10 BET button 52C, the player bets chips in a unit of ten pieces (whenever the 10 BET button 52C is pushed with a finger, the bet-number is increased in an order of “10”·“20”·“30” . . . ). Furthermore, In addition, when the player pushes the 50 BET button 52D, the player can bet chips in a unit of 50 pieces (whenever the 50 BET button 52D is pushed with a finger, the bet-number is increased in an order of “50”·“100”·“150” . . . ). Accordingly, even when many chips are bet, an operation thereof can be simplified.

In addition, the cashout result indicator 53 displays the number of chips bet by a player in a previous game and the cashout credit-number. Here, the subtraction of the bet-number from the cashout credit-number results in a credit-number that is newly obtained by a player in a previous game.

Furthermore, the credit-number indicator 54 displays the number of credits possessed by a current player. When a chip is bet, the credit-number is decreased in proportional to the bet-number (one credit for one bet). In addition, when a win is determined for the chip bet and the cashout of credits is performed, the credit-number is increased as the cashout-number. In the mean time, when the credit-number possessed by a player is 0, the game is over.

In addition, the BET timer count 55 displays a remaining time for which a player can make a bet. After a bet time is started, a number of the count is gradually decreased. When the number becomes “0”, a time for which a bet can be made in a current game is over. In addition, when the BET timer count 55 reaches a specific number (10, in this embodiment), a ball 27 is introduced in the wheel 22 from the ball insertion device of the wheel.

In addition, a cursor 65 showing the bet area 72 selected by a player is displayed on the table-type betting board 60. Additionally, a chip mark 66 showing the number of chips that are bet up to now and the bet area is displayed and the number shown on the chip mark 66 indicates the number of chips bet. For example, as shown in FIG. 5, the chip mark 66 of “7”, which is put on a combination of “1” and “2” of the dices shown in the cursor 65, indicates that 7 chips are bet on a combination of “1” and “2” as win numbers. Like this, the method of making a bet on a combination of two numbers is a bet-type referred to as a “Pair Match”.

When a player wants to make a general bet in the BET screen 50 structured as described above, the player indicates a bet area 57, 58, 59, 60A, 66B, 61, 62, 63 to be bet on the screen and directly pushes it with a finger. As a result, the cursor 65 is moved to the bet area indicated. Then, when the respective unit buttons (1 BET button 52A, 5 BET button 52B, 10 BET button 52C, 50 BET button 52D) of the unit BET buttons are pushed, the chips as the unit number are bet on the bet area indicated. For example, when the 10 BET button 52C is pushed four times, the 5 BET button 52B is pushed one time and the 1 BET button 52A is pushed three times, 48 chips can be bet.

The BET decision button 47 is a button that is pushed when a bet is decided after a bet operation is made through the image display device 8. Then, a bet is decided. In addition, when a bet is made on the bet area corresponding to the number indicated on the numbered plate 23 into which the ball 3 is received in the roulette unit 3 during a game, a win is determined. When a win is determined, the credits calculated on the basis of the number of chips bet and the payout odds relating to the bet area that wins are added to the credits that are possessed by a player. In the mean time, the bet operation will be specifically described later.

The cashout button 48 is a button that is typically pushed when a game is over. When the cashout button 48 is pushed, the medals (typically, one medal per one credit) relating to the credits, which are acquired through a game and the like and are currently possessed by a player, are cashed out from the medal payout slot 8. The help button 49 is a button that is pushed when an operation method of a game is unclear. When the help button 49 is pushed, a help screen that displays a variety of information on the image display device 8 is immediately displayed. (bet-type and payout odds corresponding to the bet-type)

In the followings, the bet-type and the payout odds corresponding to the bet-type will be described with reference to FIGS. 5 and 8. As shown in FIG. 5, the chip mark 66 of “7”, which is put on a grid of a combination of “1” and “2” of a dice, indicates that 7 chips are bet on a combination of “1” and “2” as win numbers. Like this, the method of making a bet on a combination of two numbers displayed in the bet area 58 is a bet-type referred to as a “Pair Match”. Regarding this, the payout odds is 5:1, as shown in FIG. 8. For example, for a case where a bet is made on a “Pair Match” of “3 and 5”, when three balls 27 roll on the wheel 22 and at least two balls become 3 and 5, a win is determined. When the win numbers become 4, 3 and 5, five times of the chips bet are paid out. For the “Pair Match”, a victory prize is paid out only for one combination. In other words, when the win numbers become 3, 5 and 5, a victory prize is paid out for one combination. To the contrary, for a case where a bet is made on two or more “pair matches”, when a win number is determined for the corresponding bet, a victory prize is paid out for each of the combinations.

In addition, there is a “Numbers Bet” in which a bet is made on one number displayed on the bet area 57. In this bet-type, the payout odds is changed depending on how many the win numbers bet conform to the three win numbers. When one of the three win numbers conforms to, the payout odds is 1:1, as shown in FIG. 8. When two of the three win numbers conform to, the payout odds is 2:1. When all conform to, the payout odds is 10:1. For example, for a case where a bet is made on the number of 4, when only one of the three win numbers is 4, the chip bet on the number of 4 is paid out in a ratio of 1:1. In addition, when two of the three win numbers are 4, the chip bet on the number of 4 is paid out in a ratio of 2:1. In addition, when all the three win numbers are 4, the chip bet on the number of 4 is paid out in a ratio of 10:1.

In addition, there is a “Specific Total” in which a bet is made on a summed number of the three win numbers displayed on the bet area 59. In this bet-type, when a sum of the three win numbers is 3 or 18, it means a defeat. The two numbers have no bet area on the table. The respective results show different payout odds, as shown in FIG. 8. For example, for 4 or 17, the payout odds is 60:1. For 5 or 16, the payout odds is 30:1. For 6 or 16, the payout odds is 18:1. For 7 or 14, the payout odds is 12:1. For 8 or 13, the payout odds is 8:1. For 9 or 12, the payout odds is 7:1. For 10 or 11, the payout odds is 6:1.

In addition, there is a “Specific Double” in which a bet is made on two same win numbers of three win numbers displayed on the bet area 61. In this bet-type, the payout odds is 10:1, as shown in FIG. 8. In addition, when all of the three win numbers are same and a player bets on the win number, it is also considered as a “specific double”.

In addition, there is a “Specific Triple” in which a bet is made on three same win numbers displayed on the bet area 62. In this bet-type, the payout odds is 180:1, which is a high payout, as shown in FIG. 8.

In addition, there is an “Any Triple” in which a bet is made on three same win numbers displayed on the bet area 63. In this bet-type, the payout odds is 30:1, as shown in FIG. 8.

In addition, there is a “Small Bet” (bet area 60A) and a “Big Bet” (bet area 60B) in which a bet is made on a range of a summed number of three win numbers displayed on the bet areas 60A, 60B. In this bet-type, the payout odds is always 1:1, as shown in FIG. 8. In the “Big Bet”, a bet is made on a sum 11 to 17 of the win numbers, and in the “Small Bet”, a bet is made on a sum 4 to 10 of the win numbers. When a combination of the win numbers is “Any Triple” for a bet of “Big Bet” or “Small Bet”, a defeat is made without a payout.

(Process Operations)

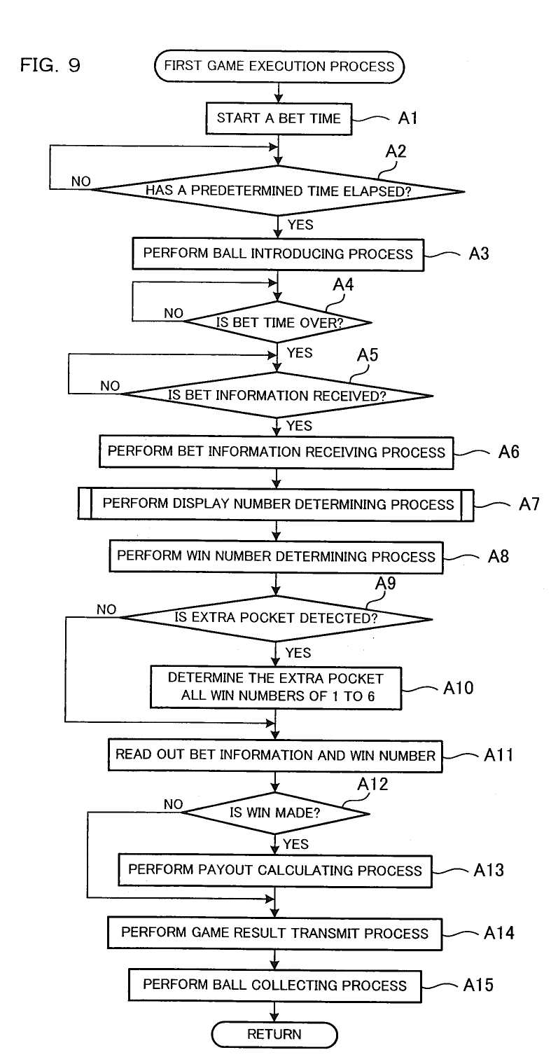

In the followings, an operation will be described, based on a first game execution process program and a second game execution process program that are performed in the server by the server control CPU 81 and a game execution process program that is performed in the station by the station control CPU 91, in the gaming machine 1. In the mean time, each program shown in flow charts of FIGS. 9, 10, 12 and 15 is stored in the ROM 82 or RAM 83 provided to the server 13, or the ROM 92 or RAM 83 provided to the station 4, and is executed by the server control CPU 81 or station control CPU 91. In the mean time, an operation by an operator of a game arcade for the keyboard 33 under state that a maintenance screen is displayed on the liquid crystal display 32 enables a setting of whether the server control CPU 81 executes a first game execution process program or second game execution process program.

(Operation 1 of a Control System of the Server: the First Game Execution Process)

In the followings, a first game execution process that is performed in the gaming machine 1 will be described with reference to FIG. 9. FIG. 9 is a flow chart of a first game execution process program of the gaming machine 1.

When a first game execution process is executed in the gaming machine 1, as the participation button 69 of any station 4 is pushed, a first game execution process is executed in the gaming machine 1 and a bet time for which a player can make a bet on the bet areas 57, 58, 59, 60A, 60B, 61, 62, 63 is started (A1). When a bet time is started, a number is decreased, as time goes by, in the electric light indicator 5 and the BET timer count 55 indicating the remaining time for which a player can make a bet. A player who takes part in a game can bet a chip on the bet areas 57, 58, 59, 60A, 60B, 61, 62, 63 that the player expects, until the number in the electric light indicator 5 and the BET timer count 55 becomes “0” (refer to FIG. 5).

Then, it is determined whether a predetermined time has elapsed (A2), after the bet time is started (A1). When it is determined that a predetermined time has not elapsed (A2, NO), the step of A2 is repeated until a predetermined time has elapsed. In the mean time, when it is determined that a predetermined time has elapsed (A2, YES), the ball insertion device is driven to introduce three balls 27 in the wheel 27 (A3).

Then, it is determined whether the bet time is over (A4) Here, the bet time is displayed by the electric light indicator 5 and the BET timer count 55, and the number thereof is decreased as time goes by, after the bet time is started (A1). When the bet time becomes “0”, the bet time in the current game is over. In the mean time, the bet time is configured so that it is over while the three balls 27 are introduced in the step of A3 and roll along the guide wall 29.

Here, before the bet time is over (A4, NO), the bet is continuously received until the bet time is over. In the mean time, when the bet time is over (A4, YES), a bet end signal is outputted to the station control units 90 of all the stations 4, an image notifying that the bet time is over is displayed on the image display devices 8 of the stations 4 and a bet operation on the touch panel 56 is prohibited. After outputting the bet end signal to all the stations 4, the server control CPU 81 determines whether the bet information (the bet area indicated and the number of chips bet on the bet area indicated) of the player is received (A5). When the bet information is not received, the step of A5 is repeated and a wait state is made (A5, NO). In the mean time, when the bet information is received (A5, YES), a bet information receiving process is performed which stores the received bet information into the RAM 83 (A6). Here, when a bet is not made on a bet area in the station 4, the information showing that a bet area is not indicated and the information showing that the number of chips bet is “0” are received, as the bet information.

Then, a display number determining process that will be described later is executed (A7). This is a process of displaying each number of “1” to “6” or the extra pocket mark 75 of “EX” on the numbered display plates 25 with a design showing the numbers of the pips of a dice, by a lottery. Thereby, the numbered pockets 23 display a design showing one letter of “1” to “6” and “EX” of the numbered display plates 25.

The three balls 27, which are introduced in the step of A3, roll on the wheel 22 along the guide wall 29 while the above process is performed. Then, when the centrifugal force is decreased as the rotation speed of the balls 27 is lowered, the balls 27 are rolled down along the inclined surface of the frame 21, are moved to the inside and reach the wheel 22 being rotated. The balls 27 roll along the wheel 22, pass over the numbered display plates 25 at the periphery of the wheel 22 being further rotated and then are received in some of the numbered pockets 23. Then, the number (one of “1” to “6”) or extra pocket mark 75 indicated by the design displayed on the numbered display plate 25 corresponding to the numbered pocket 23 having the three balls 27 received therein is handled as a win number.

Continuously, a win number determining process is executed. In this process, after the balls 27 are received in the numbered pockets 23, the server control CPU 81 drives the win number determining device 86, thereby determining the numbered pockets 23 into which the three balls 27 are received (A8). The numbers indicated by the numbered display plates 25 of the numbered pockets 23 having the balls received therein are stored, as win numbers, in the RAM 83.

Then, it is determined whether the win determining device 86 detects the extra pocket mark 75 as a win number (A9). When it is not detected (A9, NO), the process proceeds to a step of A11. In the mean time, when the extra pocket mark 75 is detected (A9, YES), the win determining device 86 determines that all of numbers of 1 to 6 are detected as a win number of the ball 27 received in the extra pocket mark 75 (A10). In other words, when the ball 27 is received in the numbered pocket 23 having the extra pocket mark 75 displayed thereon, a privilege of almighty is provided which handles all numbers of 1 to 6 as a win number. Then, all numbers of 1 to 6 are stored, as a win number, in the RAM 83.

Continuously, the bet information of each station 4 stored in the step of A4 and the win number stored in the steps of A8 and A10 are read out (A11). Then, based on the bet information and the win number, it is determined whether the chips bet in the respective stations 4 win or not (A12). When a win is made (A12, YES), the server control CPU 81 executes each payout calculating process (A13). In the payout calculating process, the win chips are recognized for each station 4, and a sum of payouts of the credits to be paid out to each station 4 is calculated using the payout odds table (refer to FIG. 8) showing the payout odds (credit-number to be paid out per one chip) for each bet area 57, 58, 59, 60A, 60B, 61, 62, 63 stored in the ROM 82. In the mean time, when it is determined that the chips bet in each station 4 do not win (A12, NO), the process proceeds to a step of A14.

After that, it is executed a game result transmit process of transmitting to all the stations 4 the payout information of the credits based on the payout calculating process in the step of A13 and the information about a change in the display of the BET screen 50, which is accompanied with the determination of the win number (A14). When paying out the credits in the station 4, the credit data corresponding to the payout amount is transmitted from the server 13 to the station control unit 90 of the station 4 for which a win is made. The credit data is added to the RAN 93 of the corresponding station 4.

Then, the ball collection device provided below the wheel 22 is driven to collect the three balls 27 on the wheel 22 (A15). The three balls 27 collected will be again introduced on the wheel 22 in a game after next. Then, the process returns to the step of A1 and is transited to a next game.

(Operation 2 of the Control System of the Server: Display Number Determining Process)

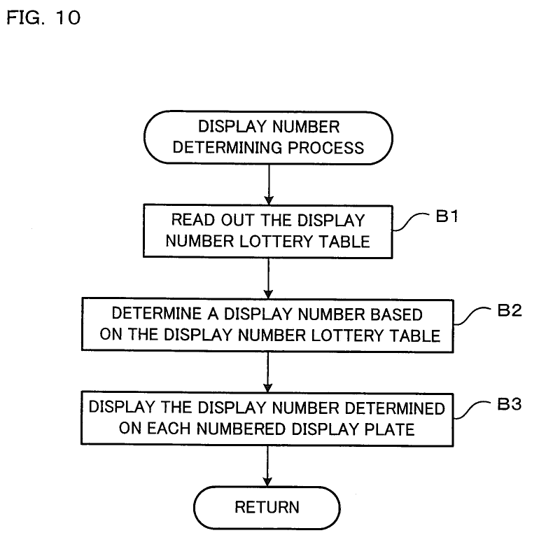

In the followings, a display number determining process that is executed during the first game execution process or second game execution process of FIGS. 9 and 5 will be described with reference to FIG. 10. In the mean time, FIG. 10 is a flow chart of a display number determining process program in the gaming machine 1.

When the display number determining process is executed, the server control CPU 81 reads out the display number lottery table (refer to FIG. 11) stored in the ROM 82 (B1). Then, based on the display number lottery table read out, the server control CPU 81 determines one number or design of the display numbers “1” to “6” represented by the pips of a dice and the design of “EX” representing the extra pocket mark 75, in a display number determination probability shown in FIG. 11 (B2). In the mean time, in this embodiment, the probability (display number determination probability) that one display number of “1” to “6” will be determined on each numbered display plate 25 is set as a value of 1/6 for all the display numbers and the probability (display number determination probability) that “EX” will be determined is set as a value of 1/38. However, the invention is not limited thereto. For example, the probabilities may be arbitrarily set or randomly changed. Then, the display number determined in the step of B2 is displayed on the numbered display plates 25 of the numbered pockets 23 (B3). Thus, the display number determining process is ended.

(Operation 1 of the Control System of the Station: Game Execution Process that is Performed in the Station)

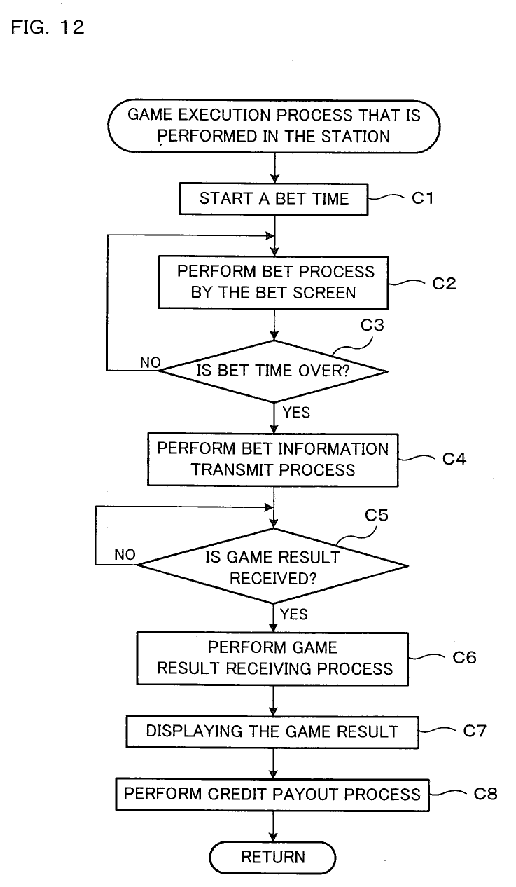

A game execution process that is performed in the station 4 will be described with reference to FIG. 12. FIG. 12 is a flow chart of a game execution process program of the station. The program shown in the flow chart is stored in the ROM 92 or RAM 93 provided to the station 4 and is executed by the station control CPU 91.

First, when a player pushes the participation button 68, the station control CPU 91 enables the image display device 8 to display a BET screen 50. Then, a game execution process is executed in the station 4.

When the BET screen 50 is displayed, it is started a bet time for which a player can make a bet on any bet area 57, 58, 59, 60A, 60B, 61, 62, 63 through the touch panel 56 on the BET screen 50 (C1). When the bet time is started, a number is decreased, as time goes by, on the BET timer count 55 that displays a remaining time for which the player can make a bet. The player who takes part in a game can bet a chip on the bet area 57, 58, 59, 60A, 60B, 61, 62, 63 that the player expects until the number in the BET timer count 55 becomes “0” (during the bet time) (refer to FIG. 5). In other words, a chip betting process by the BET screen 50 is performed (C2). In the mean time, the chip betting process by the BET screen 50 will be specifically described later.

Continuously, it is determined whether the bet time is over or not (C3). Here, the bet time is displayed on the BET timer count 55, and the number is decreased as time goes by, after the bet time is started (C1). When the number becomes “0”, the bet time in the current game is over. Before the bet time is over (C3, NO), a bet is continuously received until the bet time is over. Meantime, when the bet time is over (C3, YES), a result of the bet information (the “bet area indicated” and the “bet-number indicated”) made in the bet process of C2 is transmitted to the server control CPU 81 of the server 13 (C4). In the mean time, the server control CPU 81 of the gaming machine 1 stores the bet information transmitted in the step of C4 into the RAM 83, as described above. In addition, the bet information transmitted to the server control CPU 81 is stored in the RAM 93 in the bet process of C2.

After that, in the gaming machine 1, a game is started on the wheel 22, and the win number relating to the drop of the ball 27 is detected by the win number determining device 86. Then, it is determined whether the payout information of the credits based on the payout calculating process in the step of A11 and the information (data of a game result) about a change in the display of the BET screen 50, which is accompanied with the determination of the win number, are received (C5). When they are not received (C5, NO), a reception wait state is made. In the mean time, when they are received (C5, YES), a game result receiving process is executed which stores the data of a game result, which is received, in the RAM 93.

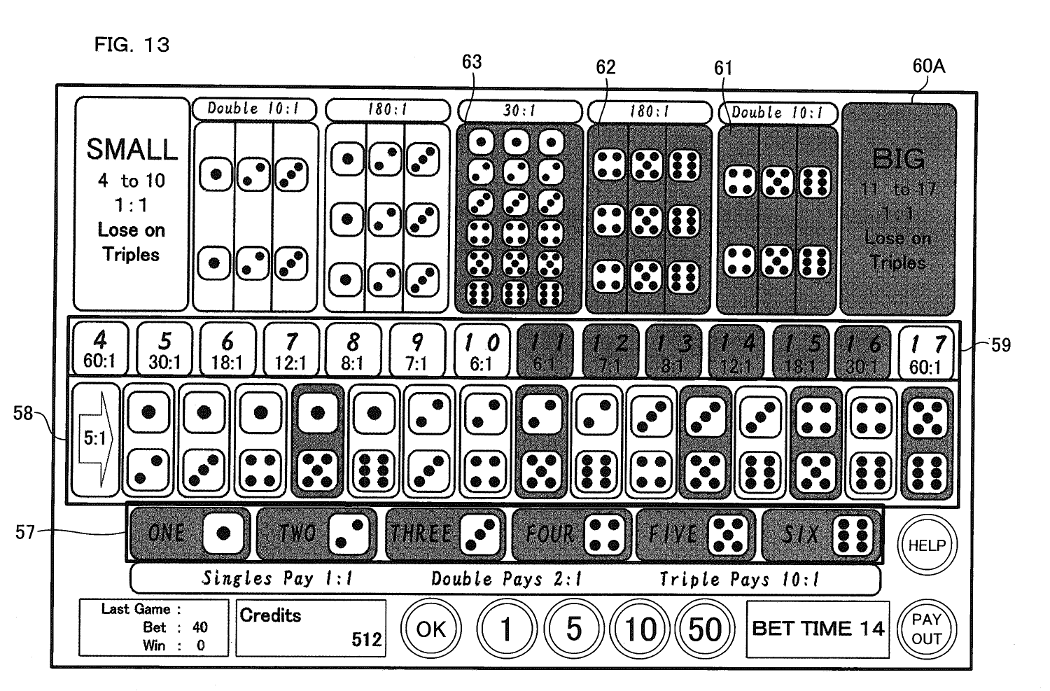

Continuously, based on the game result data received in the step of C5, a game result, which is accompanied with the determination of the win number, is displayed on the image display device 8 (C7). To be more specific, as shown in FIG. 13, when the win numbers are “5”, “5” and “1 to 6”, the numbers bet of “1”, “2”, “3”, “4”, “5” and “6” in the win bet area 57 are turned on/off. In addition, the Pair-Matches of “1” and “5”, “2” and “5”, “3” and “5”, “4”, and “5” and “6” and “5” are turned on/off. In addition, the SpecificTotals of “11”, “12”, “13”, “14”, “15” and “16” are turned on/off. Likewise, the Big-Bet of the bet area 60A, the Specific-Double of the bet area 61, the Specific-Triple of the bet area 62 and the AnyTriple of the bet area 63 are turned on/off.

In addition, based on the game result data received in the step of C5, the payout process of credits is carried out and the credits that a player currently possesses are added (C8). Then, the credit-number stored in the credit-number memory area of the RAM 93 is changed, and the cashout result indicator 53 that shows earnings and expenses of a previous game displayed on the image display device 8 and the credit-number indicator 54 that shows the current credit-number are updated. In addition, the player can know the credit-number that is currently possessed and the like by checking the cashout result indicator 53 and the credit-number indicator 54. After the above processes are over, the game execution process program that is performed in the station 4 is ended.

(Operation 2 of the Control System of the Station: Bet Process)

Continuously, the bet process by the BET screen (refer to FIG. 5) in the step of C2 will be described. Each program that executes the bet process on the BET screen 50 is stored in the ROM 92 or RAM 93 provided to the station 4 and is executed by the station control CPI 91.

First, the BET screen 50 displays the table-type betting board 51 displaying the bet areas 57, 58, 59, 60A, 60B, 61, 62, 63 and a player bets a chip, based on the table-type betting board 51.

A bet-number of chips to be bet is set in the bet area selected. When a player pushes each unit button (1 BET button 52A, 5 BET button 52B, 10 BET button 52C, 50 BET button 52D) of the unit BET buttons, the chips as the unit number are bet on the bet area indicated. On the table-type betting board 51, a chip mark 66 showing the number of chips bet up to now and the bet area is displayed and the bet-number of chips is displayed by the number shown on the chip mark 66 (refer to FIG. 5). In the mean time, the bet information by the process (the “bet area indicated”, the “bet-number indicated”) is stored in the bet information memory area of the RAM 93 at all times.

Then, the station control CPU 91 determines whether the BET decision button 47 is pushed. The BET decision button 47 is a button that is pushed when a series of bet operations are decided.

When the BET decision button 47 is pushed, abet is decided. After the bet is decided, a bet operation cannot be performed until a next game is started. In addition, after the bet is decided, when a bet is made on the bet area corresponding to the number indicated on the numbered display plates 25 corresponding to the numbered pockets 23 having the three balls 27 received therein, in the wheel 22 on which a game is started, a win is made. When a win is made, the credits relating to the number of chips bet are added to the credits that are currently possessed by a player.

When the BET decision button 47 is not pushed, it is continuously determined whether the bet time is over or not. The bet time is displayed by the BET timer count 55 provided at the lower part of the BET screen 50. The BET timer count 55 is a count that displays a remaining time for which a player can make a bet, and the number thereof is gradually decreased after a game is started. When the number becomes “0”, the bet time is over.

When the bet time is not over, i.e., the number of the BET timer count 55 is not “0”, a bet process can be again made. By repeating the corresponding process, a bet process can be performed for several positions of the table-type betting board 51.

In the mean time, when the bet time is over, a bet is decided by the current bet situation. When the bet is decided, the bet process program by the BET screen 50 is ended and the process returns to the main process program of the station 4. In the mean time, when the bet is decided, a bet operation cannot be performed until a next game is started.

According to the above structure, it is possible to randomly determine and display the identification numbers of 1 to 6 and the extra pocket mark on each display device 25. In addition, when the ball 27 is received in an extra pocket, it is possible to detect, as the privilege information, all of 1 to 6, as the identification information, and to award a credit, based on the detected identification information and the bet area bet on in the station 4. Thereby, a player familiar with a roulette game may play a game using a dice with a sense same as the roulette game. In addition, a game arcade may easily enable a player of a roulette game to take part in a game using a dice. Furthermore, since it is possible to provide a player with a privilege that an extra pocket, which is not provided in a game using a dice, is handled as an almighty having the identification information indicative of any one of numbers 1 to 6, a new entertainment characteristic can be provided.

(Operation 3 of a Control System of the Server: the Second Game Execution Process)

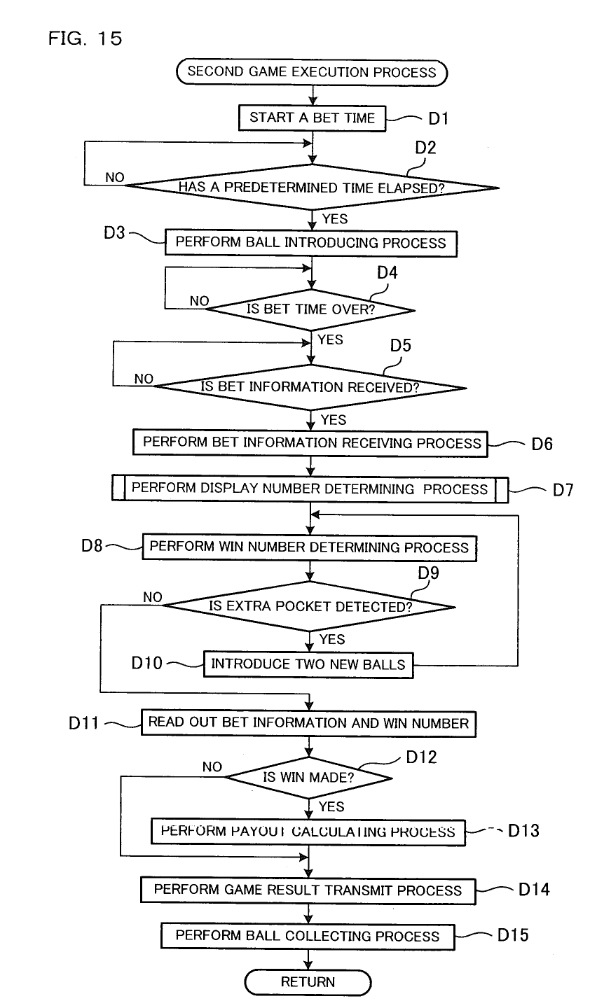

In the followings, a second game execution process that is performed in the gaming machine 1 will be described with reference to FIG. 15. FIG. 15 is a flow chart of the second game execution process program of the gaming machine 1.

When it is set that the second game execution process is executed in the gaming machine 1, as the participation button 69 of any station 4 is pushed, a second game execution process is executed in the gaming machine 1 and a bet time for which a player can make a bet on the bet areas 57, 58, 59, 60A, 60B, 61, 62, 63 is started (D1). When a bet time is started, a number is decreased, as time goes by, in the electric light indicator 5 and the BET timer count 55 indicating the remaining time for which a player can make a bet. A player who takes part in a game can bet a chip on the bet areas 57, 58, 59, 60A, 60B, 61, 62, 63 that the player expects, until the number in the electric light indicator 5 and the BET timer count 55 becomes “0” (refer to FIG. 5).

Then, it is determined whether a predetermined time has elapsed (D2), after the bet time is started (D1). When it is determined that a predetermined time has not elapsed (D2, NO), the step of D2 is repeated until a predetermined time has elapsed. In the mean time, when it is determined that a predetermined time has elapsed (D2, YES), the ball insertion device is driven to introduce three balls 27 in the wheel 27 (D3).

Then, it is determined whether the bet time is over (D4) Here, the bet time is displayed by the electric light indicator 5 and the BET timer count 55, and the number thereof is decreased as time goes by, after the bet time is started (D1). When the bet time becomes “0”, the bet time in the current game is over. In the mean time, the bet time is configured so that it is over while the three balls 27 are introduced in the step of D3 and roll along the guide wall 29.

Here, before the bet time is over (D4, NO), the bet is continuously received until the bet time is over. In the mean time, when the bet time is over (D4, YES), a bet end signal is outputted to the station control units 90 of all the stations 4, an image notifying that the bet time is over is displayed on the image display devices 8 of the stations 4 and a bet operation on the touch panel 56 is prohibited. After outputting the bet end signal to all the stations 4, the server control CPU 81 determines whether the bet information (the bet area indicated and the number of chips bet on the bet area indicated) of the player is received (D5). When the bet information is not received, the step of D5 is repeated and a wait state is made (D5, NO). In the mean time, when the bet information is received (D5, YES), a bet information receiving process is performed which stores the received bet information into the RAM 83 (D6). Here, when a bet is not made on a bet area in the station 4, the information showing that a bet area is not indicated and the information showing that the number of chips bet is “0” are received, as the bet information.

Then, the display number determining process is executed (D7). This is a process of displaying each number of “1” to “6”, which are designs showing the pips of a dice, or the extra pocket mark 75 of “EX” by a lottery. Thereby, the numbered pockets 23 are under state that a design showing any one letter of “1” to “6” and “EX” of the numbered plates 25 is displayed. Meantime, such display number determining process is same as the display number determining process in the first game execution process.

The three balls 27, which are introduced in the step of A3, roll on the wheel 22 along the guide wall 29 while the above process is performed. Then, when the centrifugal force is decreased as the rotation speed of the balls 27 is lowered, the balls 27 are rolled down along the inclined surface of the frame 21, are moved to the inside and reach the wheel 22 being rotated. The balls 27 roll along the wheel 22, pass over the numbered display plates 25 at the periphery of the wheel 22 being further rotated and then are received in some of the numbered pockets 23. Then, the number (one of “1” to “6”) or extra pocket mark 75 indicated by the design displayed on the numbered display plate 25 corresponding to the numbered pocket 23 having the three balls 27 received therein is handled as a win number.

Continuously, a win number determining process is executed. In this process, after the balls 27 are received in the numbered pockets 23, the server control CPU 81 drives the win number determining device 86, thereby determining the numbered pockets 23 into which the three balls 27 are received (D8). The numbers indicated by the numbered display plates 25 of the numbered pockets 23 having the balls received therein are stored, as win numbers, in the RAM 83.

Then, the win determining device 86 determines whether the extra pocket mark 75 is detected as a win number (D9). When it is not detected (D9, NO), the process proceeds to a step of D11. In the mean time, when the extra pocket mark 75 is detected (D9, YES), the ball insertion device is driven to introduce two new balls 27 in the wheel 22 (D10). In other words, when the ball 27 is received in the numbered pocket 23 having the extra pocket mark 75 displayed thereon, one ball 27 is resultantly increased. Therefore, a privilege that a game is executed using a total of four balls 27 is provided. Then, the win determining device 86 stores, as a win number, the number or extra pocket mark 75 indicated by the numbered display plate 25 of the numbered pocket 23 having the two new balls 27 received therein.

In the mean time, when the ball 27 is additionally received in the extra pocket mark 75, the step of D10 is again repeated and the ball 27 to be introduced is increased on all such occasions.

Continuously, the bet information of each station 4 stored in the step of D6 and the win number stored in the steps of D8 and D10 are read out (D11). Then, based on the bet information and the win number, it is determined whether the chips bet in each station 4 win or not (D12). When a win is made (D12, YES), the server control CPU 81 executes each payout calculating process (D13). In the payout calculating process, the win chips are recognized for each station 4, and a sum of payouts of the credits to be paid out to each station 4 is calculated using the payout odds table (refer to FIG. 8) showing the payout odds (credit-number to be paid out per one chip) for each bet area 57, 58, 59, 60A, 60B, 61, 62, 63 stored in the ROM 82. In the mean time, when it is determined that the chips bet in each station 4 do not win (D12, NO), the process proceeds to a step of D14.

After that, it is executed a game result transmit process of transmitting to all the stations 4 the payout information of the credits based on the payout calculating process in the step of D13 and the information about a change in the display of the BET screen 50, which is accompanied with the determination of the win number (D14). When paying out the credits in the station 4, the credit data corresponding to the payout amount is transmitted from the server 13 to the station control unit 90 of the station 4 for which a win is made. The credit data is added to the RAM 93 of the corresponding station 4.

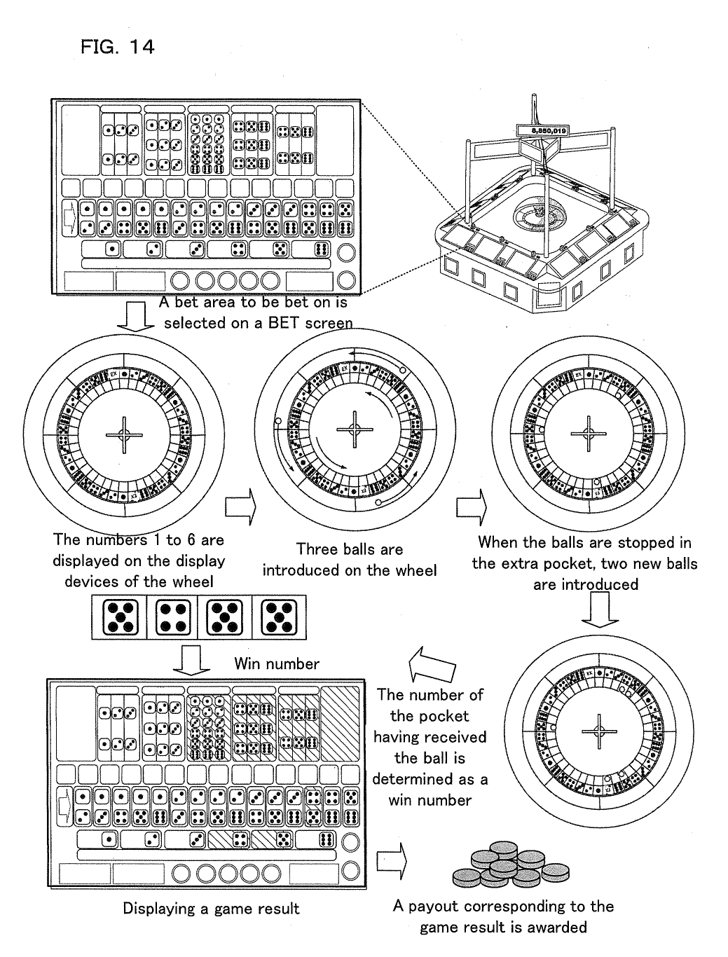

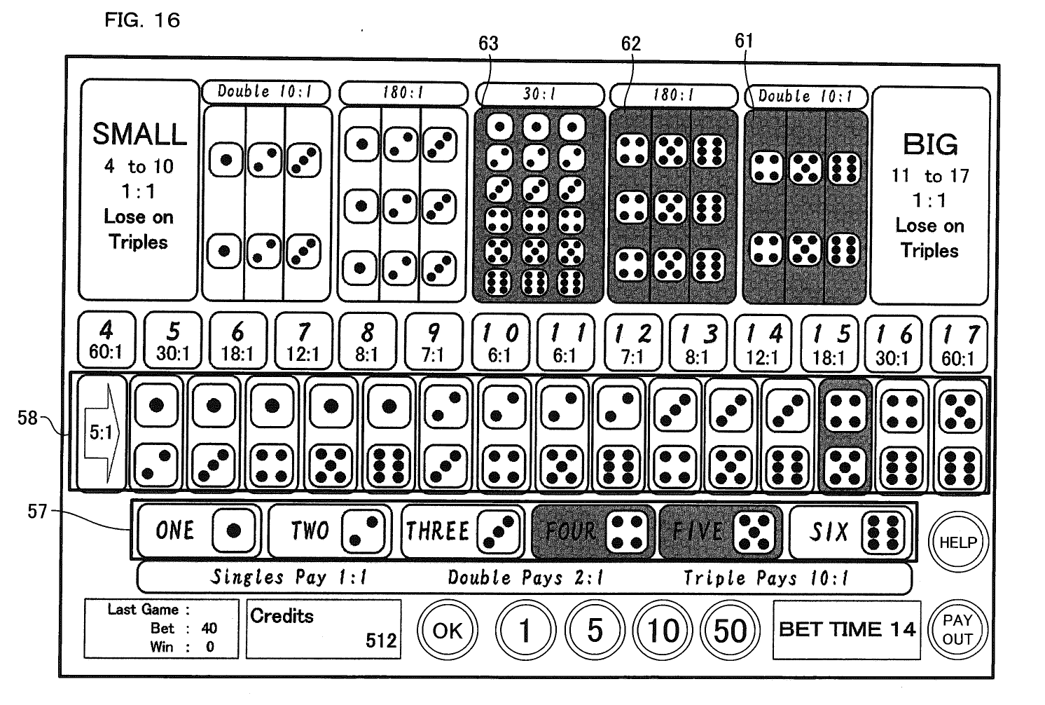

In addition, as shown in FIGS. 14 and 16, when the win numbers are “5”, “5”, “4” and “5”, the Numbers-Bets of “4” and “5” in the win bet area 57 are turned on/off on the BET screen 50. In addition, the Pair-Match of “4” and “5” in the bet area 58 is turned on/off. Likewise, the Specific-Double of the bet area 61, the Specific-Triple of the bet area 62 and the AnyTriple of the bet area 63 are turned on/off.

Then, the ball collection device provided below the wheel 22 is driven to collect the ball 27 on the wheel 22 (A15). The collected ball 27 will be again introduced on the wheel 22 in a game after next. Then, the process returns to the step of D1 and proceeds to a next game.

In the mean time, the display number determining process, the game execution process that is performed in the station and the bet process, which are accompanied with the second game execution process, are same as in the first game execution process. Therefore, the descriptions thereof will be omitted.

According to the above structure, it is possible to randomly display the identification numbers of 1 to 6 and the extra pocket mark on the numbered display plates 25. In addition, when a game is executed which uses a cube dice having the numbers of 1 to 6 indicated on each side thereof, a roulette to foresee when a ball, which is thrown on a wheel 22 being rotated, will fall can be used, instead of the dice. In addition, when the ball 27 is received in an extra pocket, it is possible to roll two new balls on the wheel, as privilege information, and to award a credit based on the identification information indicative of any one of numbers 1 to 6 and the bet area bet on in the station 4. Thereby, a player familiar with a roulette game may play a game using a dice with a sense same as the roulette game. In addition, a game arcade may easily enable a player of a roulette game to take part in a game using a dice. Furthermore, since it is possible to provide a player with a privilege that an extra pocket, which is not provided in a game using a dice, is used to execute a game with the more balls than a base game, a new entertainment characteristic can be provided.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine that executes a game using identification information indicative of any one of numbers 1 to 6, the gaming machine comprising:
a wheel having pockets including a plurality of numbered pockets to which the identification information indicative of any one of numbers 1 to 6 is allotted and an extra pocket to which privilege information is allotted;
at least one ball that rolls on the wheel and is received in any one of the pockets;
a win information detection device that detects the identification information allotted to the numbered pockets and the privilege information allotted to the extra pocket;
a terminal device that has a plurality of bet areas corresponding to the identification information, and receives a game value placed as a bet on one or more of the bet areas and awards a payout, based on odds defined for the bet areas; and
a controller that operates:
(a1) to store a bet area bet on and a game value placed as a bet in the terminal device;
(a2) to roll the ball on the wheel;
(a3) when the ball is received in the extra pocket, to award a privilege, based on the privilege information detected by the win information detection device; and
(a4) when the ball is received in any one of the plurality of pockets and the identification information detected by the win information detection device conforms to the bet area bet on in the terminal device, to award a payout based on odds defined for the conforming bet area bet on and the game value placed as a bet on the bet area.

2. The gaming machine according to claim 1, wherein the number of the numbered pockets is thirty six and that of the extra pockets is two.

3. The invention provides the gaming machine according to claim 1, wherein a game to be executed is a Sic Bo that uses three balls and has a bet area relating to a combination of the three balls.

4. A gaming machine that executes a game using identification information indicative of any one of numbers 1 to 6, the gaming machine comprising:
a wheel having a plurality of numbered pockets to which the identification information indicative of any one of numbers 1 to 6 is allotted and an extra pocket having the identification information indicative of any one of numbers 1 to 6;
at least one ball that rolls on the wheel and is received in any one of the numbered pockets and the extra pocket;
a win information detection device that detects the identification information allotted to the numbered pocket or extra pocket having received the ball;
a terminal device that has a plurality of bet areas corresponding to the identification information, and receives a game value placed as a bet on one or more of the bet areas and awards a payout, based on odds defined for the bet areas; and
a controller that operates:
(b1) to store a bet area bet on and a game value placed as a bet in the terminal device;
(b2) to roll the ball on the wheel;
(b3) when the ball is received in the extra pocket, to detect all of 1 to 6, as identification information; and
(b4) when the ball is received in at least one of the numbered pockets and the extra pocket and the identification information detected by the win information detection device conforms to the bet area bet on in the terminal device, to award a payout, based on odds defined for the conforming bet area bet on and the game value placed as a bet on the bet area.

5. The gaming machine according to claim 4, wherein the number of the numbered pockets is thirty six and that of the extra pockets is two.

6. The gaming machine according to claim 4, wherein a game to be executed is a Sic Bo that uses three balls and has a bet area relating to a combination of the three balls.

7. A gaming machine that executes a game using identification information indicative of any one of numbers 1 to 6, the gaming machine comprising:
a wheel having a plurality of numbered pockets to which the identification information indicative of any one of numbers 1 to 6 is allotted and an extra pocket to which privilege information is allotted;
a ball that rolls on the wheel and is received in any one of the numbered pockets and extra pocket;
a win information detection device that detects the identification information allotted to the numbered pockets or the privilege information allotted to the extra pocket;
a terminal device that has a plurality of bet areas corresponding to the identification information, and receives a game value placed as a bet on one or more of the bet areas and awards a payout, based on odds defined for the bet areas; and
a controller that operates:
(c1) to store a bet area bet on and a game value placed as a bet in the terminal device;
(c2) to roll the ball on the wheel;
(c3) when the ball is received in the extra pocket and the privilege information is detected, to roll a plurality of new balls on the wheel; and
(c4) when the new balls are received in any one of the numbered pockets and the identification information detected by the win information detection device conforms to the bet area bet on in the terminal device, to award a payout, based on odds defined for the conforming bet area bet on and the game value placed as a bet on the bet area.

8. The gaming machine according to claim 7, wherein the number of the numbered pockets is thirty six and that of the extra pockets is two.

9. The gaming machine according to claim 7, wherein a game to be executed is a Sic Bo that uses three balls and has a bet area relating to a combination of the three balls.

10. A gaming machine that executes a game using identification information indicative of any one of numbers 1 to 6, the gaming machine comprising:
a wheel having a plurality of numbered pockets each of which has a display device that displays the identification information and an extra pocket mark;
at least one ball that rolls on the wheel and is received in any one of the numbered pockets;
a win information detection device that detects the identification information and the extra pocket mark displayed on the display device provided to the numbered pocket having received the ball;
a terminal device that has a plurality of bet areas corresponding to the identification information, and receives a game value placed as a bet on one or more of the bet areas and awards a payout, based on odds defined for the bet areas; and
a controller that operates:
(d1) to store a bet area bet on and a game value placed as a bet in the terminal device;
(d2) to randomly determine and display identification numbers of 1 to 6 and the extra pocket mark on each display device;
(d3) to roll the ball on the wheel;
(d4) when the ball is received in the numbered pocket having the extra pocket mark displayed thereon and the extra pocket mark is detected, to detect all of 1 to 6, as identification information; and
(d5) when the ball is received in any one of the numbered pockets and the identification information detected by the win information detection device conforms to the bet area bet on in the terminal device, to award a payout, based on odds defined for the conforming bet area bet on and the game value placed as a bet on the bet area.

11. The gaming machine according to claim 10, wherein a game to be executed is a Sic Bo that uses three balls and has a bet area relating to a combination of the three balls.

12. A gaming machine that executes a game using identification information indicative of any one of numbers 1 to 6, the gaming machine comprising:
a wheel having a plurality of numbered pockets each of which has a display device that displays the identification information and an extra pocket mark having privilege information allotted thereto;
a ball that rolls on the wheel and is received in any one of the numbered pockets;
a win information detection device that detects the identification information or the privilege information allotted to the extra pocket mark, the identification information and the privilege information being displayed on the display devices provided to the numbered pockets;
a terminal device that has a plurality of bet areas corresponding to the identification information, and receives a game value placed as a bet on one or more of the bet areas and awards a payout, based on odds defined for the bet areas; and
a controller that operates:
(e1) to store a bet area bet on and a game value placed as a bet in the terminal device;
(e2) to randomly determine and display identification information indicative of any one of numbers 1 to 6 and the extra pocket mark on each display device;
(e3) to roll the ball on the wheel;
(e4) when the ball is received in the numbered pocket having the extra pocket mark displayed thereon and the privilege information is detected, to roll a plurality of new balls on the wheel; and
(e5) when the new balls are received in any one of the numbered pockets and the identification information detected by the win information detection device conforms to the bet area bet on in the terminal device, to award a payout, based on odds defined for the conforming bet area bet on and the game value placed as a bet on the bet area.

13. The gaming machine according to claim 12, wherein a game to be executed is a Sic Bo that uses three balls and has a bet area relating to a combination of the three balls.

14. A playing method of a game in which identification information indicative of any one of numbers 1 to 6 is used to repeatedly perform a game, the playing method comprising the steps of:
storing a bet area bet on, which area corresponds to the identification information, and a game value placed as a bet;
rolling a ball on a wheel having pockets including a plurality of numbered pockets to which the identification information indicative of any one of numbers 1 to 6 is allotted and an extra pocket to which privilege information is allotted; and
when the ball is received in the extra pocket, awarding a privilege, based on the privilege information, and
when the ball is received in any one of the plurality of pockets and the received identification information conforms to the bet area bet on, awarding a payout, based on odds defined for the conforming bet area bet on and the game value placed as a bet on the bet area.

15. The playing method according to claim 14, wherein the number of the numbered pockets is thirty six and that of the extra pockets is two.

16. The playing method according to claim 14, wherein a game to be executed is a Sic Bo that uses three balls and has a bet area relating to a combination of the three balls.
